(19) United States
(12) Patent Application Publication
(10) Pub. No.: US 2013/0311211 A1
(43) Pub. Date: Nov. 21, 2013

(54) SYSTEMS AND METHODS FOR TRANSPORTATION SERVICES

(71) Applicant: AVID INTERNATIONAL HOLDINGS, INC., Studio City, CA (US)

(72) Inventors: Amir ZAFAR, Sherman Oaks, CA (US); Ian RASSMAN, Pasadena, CA (US); Reza SHAHBAZI, Westwood, CA (US); Gitte DAHL, Culver City, CA (US)

(73) Assignee: AVID INTERNATIONAL HOLDINGS, INC., Studio City, CA (US)

(21) Appl. No.: 13/691,548

(22) Filed: Nov. 30, 2012

Related U.S. Application Data
(60) Provisional application No. 61/566,507, filed on Dec. 2, 2011.
(60) Provisional application No. 61/566,499, filed on Dec. 2, 2011.

(51) Int. Cl. G06Q 10/02

(52) U.S. Cl. CPC G06Q 10/02
USPC 705/5

(57) ABSTRACT

Systems, methods, processes, computer readable medium, networks, virtual machines are provided that implement transportation related features and services. For example, a platform is implemented that address the complexity and speed in providing and managing chauffeured for hire ground transportation services. Features related to dispatching, managing business agreements, user interfaces, inter-company billing, inter-company fleet visibility and verification, analytics, and other advancements are also described.

### FIELD OF THE INVENTION

The general field is the field of systems and methods that facilitate business-to-business operations such as for ground transportation services through various techniques such as integration, affiliation, dispatch, data communications, data extraction, graphical user interface and validation systems.

### BACKGROUND OF THE INVENTION

Customers who travel between locations may often require the assistance of chauffeured ground transportation. As one solution to this problem, customers may call a chauffeured ground-transportation-for-compensation (or hire) service provider and arrange a limousine service for a wedding or a “black sedan” service to take them from offices in a downtown location to offices in a suburban location. As shown in FIG. 1A, the market for this chauffeured ground transportation may consist of a variety of operators 14, 16, and 18 providing vehicles and drivers for hire or compensation to customers (who may also be referred to as livery car service providers). Some of these operators may be referred to as independent operators (e.g. 16 and 18), while others may be referred to as corporate operators or fleet operators (e.g., 14). These two groups of operators are not clearly distinct, but are generally distinguished among service providers along the following lines. Independent operators 16 and 18 tend to own only a few vehicles and have a very limited supply of drivers (e.g., the owner is often the only driver in the company). They also tend to have minimal infrastructure for operating their businesses, as generally the complexity of running the business is small. Corporate operators 14, on the other hand, tend to own a variety of vehicles, tend to have a substantial number of employees and contractors engaged as drivers and tend to have substantial infrastructure for operating their businesses. In addition to the differences that distinguish independent and corporate operators, it is a general practice in the industry for each service provider of either type to limit operations to a specific geographic area. For example, service providers 14 and 16 may cover the Los Angeles market 10 for chauffeured ground transportation, while service provider 18 may cover the Orange County market 12.

Among such service providers who offer chauffeured ground transportation services, situations often occur where service providers need affiliate service providers to provide chauffeured ground transportation services to a customer on their behalf. For example, if a high profile celebrity event occurs (e.g., the Oscars), demand for certain types of chauffeured ground transportation may exceed a service provider's inventory of such vehicles (e.g., limousines). For instance, a corporate operator (e.g., 14) may engage an independent operator (e.g., 16) to provide additional chauffeured ground transportation services (e.g., additional limousines) on its behalf. As another example, a regular client of the service provider may ask to reserve chauffeured ground transportation service outside of a service provider's coverage area. Even though a customer could engage a new service provider to supply chauffeured ground transportation, customers often prefer to work with their usual service providers. This allows the customer the convenience of working with people familiar with its needs, while also gaining the benefit of established relationships between service providers for dealing with such situations. As a result, a customer who requests chauffeured ground transportation that cannot be provided by a service provider may nonetheless receive such services from an affiliate service provider, but will still experience substantially similar customer service as if the service provider was in fact providing the service (e.g. making a reservation and paying for services). For instance, a customer may call its usual service provider (e.g., 18) and book service for a market generally not served by the customer (e.g., 10). If the service provider has an affiliation agreement with another service provider in that market (e.g., 14), it may arrange with that affiliate service provider to obtain chauffeured ground transportation on its behalf without generally having to involve the customer.

A problem for both kinds of service providers is that generally there is no mechanism for sharing collective information about capabilities (e.g., available vehicles) between service providers such as having visibility into other companies' fleet schedules. For example, if a service provider wishes to reserve chauffeured ground transportation with an affiliate, determining availability may require time consuming calls and coordination. Moreover, Internet services for such service providers are not able to regulate interactions between the service providers based on their affiliation agreements. As such, there is a need in the market of chauffeured ground transportation services for an industry-focused platform or technology that allows for an efficient and regulated exchange of information between affiliated service providers.

The prior art does not address these and other deficiencies in providing an platform (e.g., an open platform) for ground travel organizations. An open platform, for example, facilitates coordination and collaboration in business and seamlessly distributes reservations regardless of which legacy systems might be in current use among a network of ground transportation service providers.

The black sedan or livery car industry also faces business and technological challenges that are particular to that industry and not necessarily in other industries such as the taxi service industry. For example, the livery car industry has a different clientele, different business model (e.g., longer trips as compared to taxis), a dependence on corporate reservations (locally or when clients travel to other cities), and different government regulations. The industry is also one that is slow to adopt or incorporate technology.

### SUMMARY

A computer implemented business platform for business-to-business operations between chauffeured ground transportation service providers, comprising: multiple virtual machines implemented in a network of computers that is configured and adapted to support multiple service providers over a network communications connection, wherein the multiple virtual machines provide access to use the business platform to the service providers that are registered with the business platform and stores service provider specific data comprising a first portion and a second portion: a reservation element implemented on one or more of the virtual machines; a reservation transaction object database that stores reservation objects detailing individual reservation transactions; an availability engine that collects and analyzes service provider information and determines availability of the service providers to schedule a pick up at particular times and geographic areas: a regulatory element that implements a set of electronic constraints between particular service providers, wherein the constraints create and control affiliate relationships, and controls usage of at least the first and second portions of the service provider specific data; a search element that receives data requirements specifying one or more reservations including a customer pickup time, wherein the search element is configured and adapted to receive the data requirements and generate an output response based on the data requirements, the second portion of service provider data, and the electronic constraints: and a reservation interface element that is configured and adapted to permit a first service provider to select one of its affiliated service providers for a reservation, wherein the interface permits the first service provider to select an affiliated service provider from the output response to specify that the affiliated service provider should handle the reservation and generates an update to a data field that records the selection by the first service provider of the particular affiliate service provider to handle the reservation.

In the platform, the reservation interface can be a component of the reservation element. The reservation transaction object database can be stored on the network of computers. One or more of the virtual machines can implement the availability engine. One or more of the virtual machines can implement the regulatory element. One or more of the virtual machines can implement the search element. One or more of the virtual machines can implement the reservation interface. The platform can store for each service provider fleet data specifying details of its chauffeured motor ground transportation vehicles.

The availability engine can be configured to determine availability by performing an operation that deduces availability using the collected service provider specific data. The platform can store number of vehicles in a service provider fleet and obtain scheduled reservation made service provider and prevents affiliated service provider from being able to retrieve the number of vehicles or specifics of scheduled reservations. The update is made to a corresponding reservation transaction object. In response to the update, a message comprising the reservation can be sent to the affiliate service provider. The platform can be configured to receive and store an indication that the affiliate service provider has accepted the reservation. The platform is configured to receive a confirmation code for the affiliate service provider responsive to the update. The platform can be configured to store data for a reservation code and a confirmation code in a transaction database object corresponding to the reservation, wherein the confirmation code is code data that is provided to the platform by the affiliate service provider.

A validation element can be implemented that records data and confirms using the recorded data that the service providers are in compliance with ground transportation operation requirements from third party sources and is further configured to determine which service providers are not in compliance or will need to update their ground transportation requirements and in response notifies service providers with sufficient information that one or more its affiliate service provider are not compliance or will need to update their status.

A validation element can be implemented that records data and confirms using the recorded data that the service providers are in compliance with ground transportation operation requirements from third party sources and notifies affiliated service providers of a result of the confirmation.

The platform can include a validation element that implements a process for decoding a vehicle identification number.

The platform can include a validation element that verifies fleet information of service providers using vehicle identification numbers and provides the verified information to the availability engine.

The search element can be configured to include in its searching operation an availability of a requesting service provider that initiated the data requirement and include the availability in the output response. The search element includes a calendar view.

The platform can be configured to communicate with adapters that provide an interface between third party systems and the platform.

In some embodiments, the reservation transaction object is a standardized object.

The platform can be configured to provide a web interface for a service provider that implements an instance of an application that is configured to allow the service provider to create, manage, record, and handle reservations from its own customers.

The platform can store a rating for each service provider. The regulatory element implements and tracks different price rate arrangements that a service provider has with each of its affiliate service providers.

The search element can use different price relationships that a requesting service provider has with each of its affiliate service providers in generating the output response.

The platform can be configured such that the first portion of each service provider specific data is visible to non-affiliated service providers on the business platform.

The platform can be configured such that the second portion of each service provider specific data is at least representative of each service provider's fleet capability or each service provider's scheduled reservations.

The platform can be configured such that the second portion comprises service provider specific information that is available to the search element when service providers establish an affiliate relation between each other using the regulatory element.

The platform can be configured such that the availability engine is configured to include in its determination of availability a particular service provider's own fleet information and fleet information of affiliates of that service provider.

The platform can be configured such that the platform is configured to permit a service provider to confirm a reservation on the platform only when the provider is registered on the platform and the platform has verified service provider information using the regulatory element.

The platform can be configured such that the regulatory element provides individual service providers with the opportunity to select their respective service providers and put them into different categories including primary and secondary.

A computer implemented business platform for business-to-business operation between chauffeured ground transportation service providers, comprising: a reservation element that is configured to handle the creation and management of a service-provider-to-service-provider reservation for chauffeured motor ground transportation; a reservation transaction object database that stores reservation objects detailing individual reservation transactions: a regulatory element that implements a set of electronic constraints between particular service providers, wherein the constraints create and control affiliate relationships between the service providers: a validation element that records data and confirms using the recorded data that the service providers are in compliance with ground transportation operation requirements from third party sources and is further configured to determine which service providers are not in compliance or will need to update their ground transportation requirements and in response notifies service providers with sufficient information that one or more its affiliate service provider are not compliance or will need to update their status; and a reservation interface element that is configured and adapted to permit a first service provider to select one of its affiliated service providers for a reservation, wherein the interface permits the first service provider to select an affiliated service provider from the output response to specify that the affiliated service provider should handle the reservation and generates an update to a data field that records the selection by the first service provider of the particular affiliate service provider to handle the reservation.

The validation element can use a VIN decoder to verify service provider information.

The validation element can be configured to verify information provided to the platform by service provider and wherein verification is a requirement to being able to use the reservation interface.

The platform can store and use quality ratings specified for individual service providers.

The platform wherein the platform requires that each service provider can only be on the platform when the platform has verified the service provider's fleet information.

The regulatory element can provide individual service providers with the opportunity to select their respective service providers and put them into different categories including primary and secondary.

The platform wherein the search element that receives data requirements specifying one or more reservations including a customer pickup time, wherein the search element is configured and adapted to receive the data requirements and generate an output response based on the data requirements, the second portion of service provider data, and the electronic constraints.

A computer implemented method for business-to-business operations between chauffeured ground transportation for compensation service providers, comprising: configuring multiple virtual machines implemented on a network of computers to provide service providers with access to a business platform; storing service provider specific data for each service provider, wherein each service provider specific data comprises a first portion and a second portion; creating a reservation transaction object, wherein creating the reservation transaction object includes storing the reservation transaction object in a reservation transaction object database; collecting and analyzing the service provider specific data to determine the availability of the service providers to schedule a pick up at particular times and geographic areas; implementing a set of electronic constraints between the service providers, wherein the constraints create and control affiliate relationships and control usage by the service providers of at least the first and second portions of the collected service provider specific data; receiving data requirements specifying one or more reservations including a customer pickup time; generating an output response based on the data requirements, one or more second portions of the collected service provider specific data, and the electronic constraints; displaying the output response to a first service provider; receiving a selection of an affiliated service provider from the output response for the purpose of specifying that the affiliated service provider should handle the reservation; and generating an update to a data field that records the selection by the first service provider.

A computer implemented business platform for business-to-business operation between chauffeured ground transportation service providers, comprising: a reservation element that is configured to handle service-provider-to-service-provider reservation for chauffeured motor ground transportation; a reservation transaction object database; a regulatory element; a validation element; and a reservation interface element that is configured and adapted to permit a first service provider to select one of its affiliated service providers for a reservation.

A computer implemented business platform for business-to-business operation between transportation service providers, comprising: a reservation element that is configured to handle service-provider-to-service-provider reservation for transportation by clients of a requesting service provider to travel with a providing service provider, a reservation transaction object database; a regulatory element, a validation element, and a reservation interface element that is configured and adapted to permit a first service provider to select one of its affiliated service providers for a reservation.

A computer implemented business platform for business-to-business operation between transportation service providers, comprising: a reservation element that is configured to handle service-provider-to-service-provider reservation for transportation by clients of a requesting service provider to travel with a providing service provider, a reservation transaction object database; and an element that stores data representative of vehicle identification numbers for vehicles for one or more individual transportation service providers and confirms validity of vehicle information using the data; and a reservation interface element that is configured and adapted to permit a first service provider to make a reservation with an affiliated service provider for a reservation. The platform of claim 44 wherein the element stores vehicle identification numbers issued by manufacturers of ground transportation vehicles.

The platform wherein the platform is configured to use the data to generate one or more output that informing users of vehicle capacity in correspondence with the data representative of vehicle information numbers.

Other aspects of the disclosed method and system will become readily apparent from the following detailed description.

### BRIEF DESCRIPTION OF THE DRAWINGS

Other features and advantages of the invention will become apparent from the following detailed description, with reference to the appended drawings in which:

FIG. 1A shows a schematic of an exemplary market for chauffeured ground transportation including a variety of operators.

FIG. 1B shows an example of a network computing environment in which embodiments of the presently disclosed system and method may be implemented.

FIG. 2 shows a schematic of an exemplary business platform provided with embodiments of the presently disclosed system and method.

FIG. 3A shows an exemplary process for accessing the business platform of FIG. 2 via a Web Interface Element.

FIG. 3B shows an example of a login screen presented by a Web Interface Element to the business platform of FIG. 2.

FIG. 4A shows an example of adapters in use with the business platform of FIG. 2 in accordance with an embodiment of the presently disclosed system and method.

FIG. 4B shows an exemplary process for transmitting and validating data being exchanged to/from the adapters of FIG. 4A.

FIG. 4C shows an exemplary standardized communication format for the adapters shown in FIG. 4A.

FIG. 4D shows an example of a gateway for performing a data validation process implemented by an Adapter Interface Element as shown in FIG. 2.

FIG. 4E shows an exemplary data validation process accessed by the gateway of FIG. 4D.

FIG. 5 shows an exemplary process for the business platform of FIG. 2 to receive tracking data from at least one GPS-enabled network device.

FIG. 6 shows an example of adapters in use as part of a Third Party Interface Element of the business platform shown in FIG. 2.

FIGS. 7A and 7B show schematic views of an exemplary applet that can be used to manage access to the business platform of FIG. 2.

FIG. 8 shows an example of service provider specific information and resources that may be managed by a service provider on the business platform of FIG. 2.

FIG. 9 shows an exemplary process for entering company information using a Management Interface Element of the business platform shown in FIG. 2.

FIGS. 10A and 100B show an exemplary process for entering vehicle information using a Management Interface Element of the business platform of FIG. 2.

FIGS. 11A and 11B show an exemplary process for entering employee information, such as regarding chauffeurs or drivers, using a Management Interface Element of the business platform shown in FIG. 2.

FIG. 12A shows an exemplary process for specifying affiliates using a Management Interface Element of the business platform shown in FIG. 2.

FIG. 12B shows an example of a rate matrix that can be entered by a service provider to show its costs for hiring various types of vehicles.

FIG. 12C shows an exemplary diagram of service operator affiliated relationships that may be implemented within the presently disclosed system and method.

FIG. 13 shows an exemplary process for determining availability of vehicles registered with the business platform of FIG. 2.

FIG. 14 shows an exemplary process for facilitating the reservation of services between service providers using a Reservation Element of the business platform shown in FIG. 2.

FIG. 15 shows an exemplary process for utilizing electronic constraints using a Regulatory Element of the business platform as shown in FIG. 2.

FIG. 16A shows an exemplary process for searching for an affiliate service provider using a Search Element of the business platform of FIG. 2.

FIG. 16B shows an example of an availability matrix generated by a Search Element of the business platform of FIG. 2

FIG. 17 shows an exemplary process for obtaining service from affiliate service providers using a Reservation Interface Element of the business platform of FIG. 2.

FIG. 18A shows an exemplary process for determining if service providers wish to provide service, using a Dispatch Interface Element of the business platform shown in FIG. 2.

FIG. 18B shows an example of a virtual fleet's available vehicle inventory.

FIG. 19 shows an exemplary process for reconciling payments for services rendered by service providers using a Management Interface Element of the business platform shown in FIG. 2.

FIG. 20A shows an exemplary process for requesting services to be performed on a service provider's behalf, using the business platform of FIG. 2.

FIG. 20B shows an example of a member self sign-in screen implemented with a Management Interface Element of the business platform of FIG. 2.

FIG. 20C shows an example of a non-member invitation screen implemented with a Management Interface Element of the business platform of FIG. 2.

FIGS. 20D, 20E, 20F, 20G, and 20H show examples of screens for a service provider to enter and manage service provider specific data on the business platform of FIG. 2.

FIG. 21 shows an example of a service provider rating feature implemented with the presently disclosed system and method.

FIGS. 22A and 22B show exemplary depictions of a service provider's vehicle fleet and availability of vehicles within the fleet, using a Live Search Element of the business platform shown in FIG. 2.

FIGS. 23A and 23B show exemplary depictions of vehicle fleet and availability information for an affiliated service provider.

FIG. 24A shows an example of a depiction of fleet information including vehicle identification numbers in table format.

FIG. 24B shows an example of a map view showing a relative proximity of fleet vehicles relative to a desired focal point.

FIG. 24C shows an example of a reservations dashboard having performance data relative to affiliated service providers in a platform community.

### DETAILED DESCRIPTION OF EMBODIMENTS

Systems and methods can be implemented that can improve chauffeured ground transportation for hire services and industry as described here. A group of service providers, e.g., a large segment of the industry, can establish electronic relationships that are governed and implemented using computers such as a network of computer resources. Such services providers can interact with a platform that implements the relationship over the Internet or through other computer network connections. The platform can scale up to meet the industry's demand in data and processing. The platform can also provide regulatory or compliance features that can help to build trust between the service providers, such as counter parties in reservation transactions. Third party data sources can also be integrated into the platform or acted upon by the platform to notify a service provider or its affiliates that it is not in compliance of some requirement (e.g., a licensing requirement). A service provider can also make decisions regarding which specific affiliate should handle service on its behalf. Pricing can be a secondary or minimal component in such processes. Standardized data objects can be implemented that, for example would hold data with respect to reservation, invoices, dispatch, and comments. A rating system can be integrated for communicating performance openly. The platform can also protect core business information of a service provider while providing sufficient information derived from such protected information to encourage business-to-business transactions.

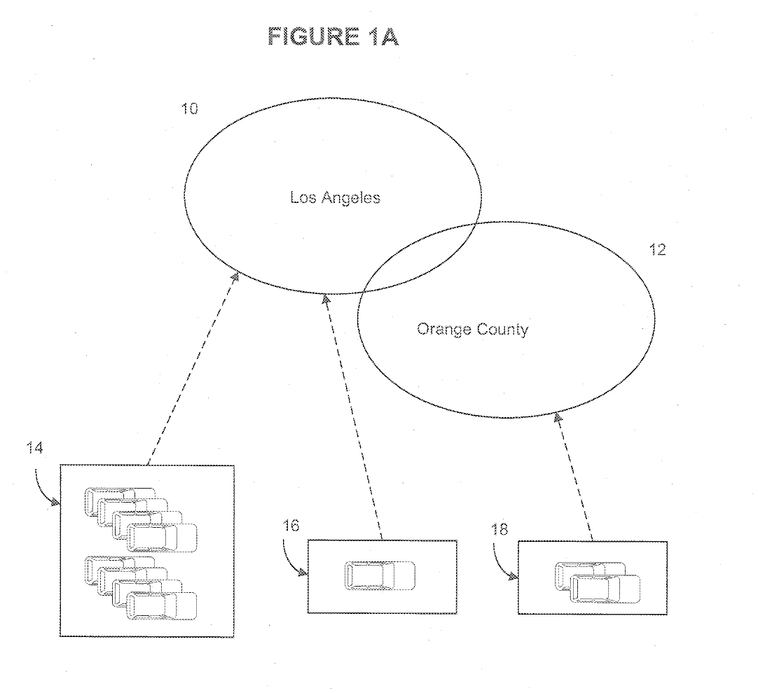

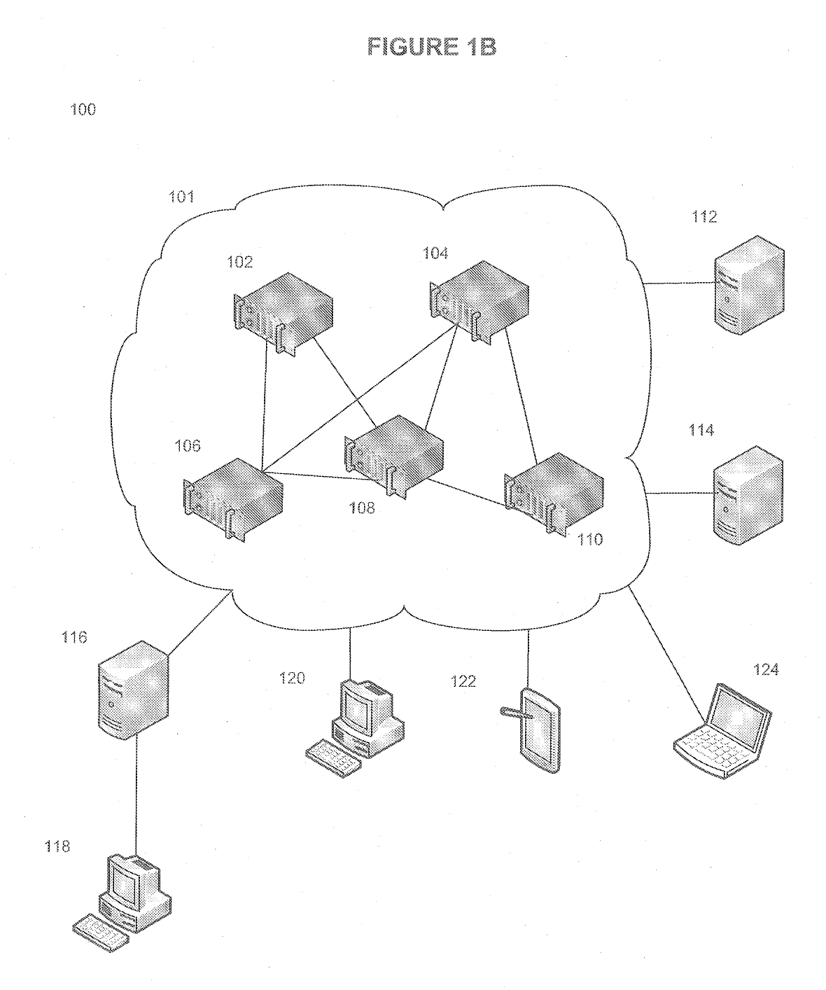

With reference now to FIG. 1B, a business-to-business system 100 may be implemented using, for example, computers 102, 104, 106, 108, and 110 arranged in a network cloud 101. Computers 102, 104, 106, 108, and 110 may be implemented using, for example, stand-alone PCs, servers, blades, database processors, and other computer processing systems. Network cloud 101 may be implemented using additional elements to control the usage of resources in the network cloud 101 by various different users or applications. Network 101 may also include storage for storing database information, software applications, audio-visuals, graphics, promotion material, etc. Referring again to FIG. 1B, computers 102, 104, 106, 108, and 110 may be arranged in a network 101 that is configured and adapted to implement multiple virtual machines. Such multiple virtual machines may then be configured to provide a platform 200 for the business-to-business operations between livery car service providers. These multiple virtual machines or network cloud 101 may also be implemented to facilitate access to platform 200 for service providers. Connections between the virtual machines and the service providers may be implemented over a variety of network connections, including wired, wireless, and optical networks or any other direct or indirect transmission system capable of conveying digital information. Service providers may use a variety of devices to establish these connections, including desktop computers 120, mobile computing devices 122 (e.g., smartphones, tablets), mobile computers 124 (e.g., laptops, net books), or any other computer capable of providing a web browser (e.g., Internet Explorer, Safari, Firefox) or running applets that interact with a network. Service providers may also use one or more software adapters 116 to connect between the virtual machines and a third party software application running on a computer 118 (e.g., Odyssey). Connections between the virtual machines and third-party systems 112 may be implemented to obtain travel information, weather information, or other services. Connections between the virtual machines and third-party systems 114 may also implemented to obtain information from third parties used to verify records maintained by the service providers or the business platform 200. Examples of such third parties with such third-party systems may include insurers, government agencies, background check organizations, credit reporting agencies, and other organizations that can be useful to determine if another service provider is operating a reputable and legal chauffeured ground transportation service.

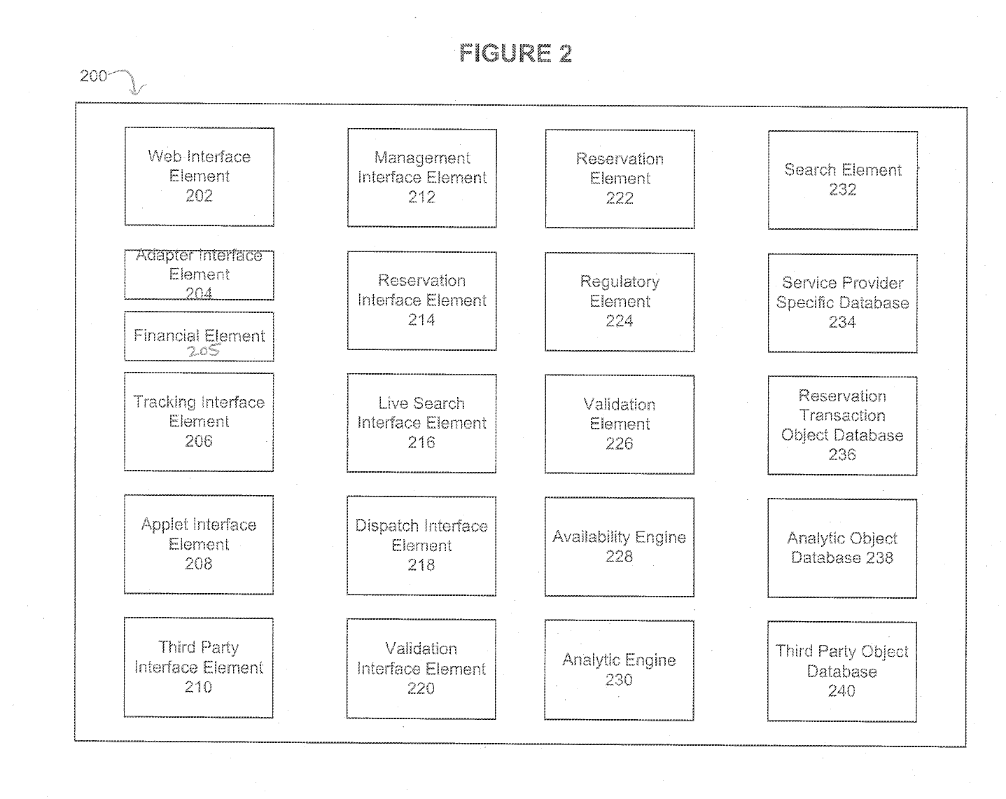

With reference now to FIG. 2, business platform 200 may be implemented using a number of elements, engines, and databases as described below. An element can be a functional module such as a computer program that is in executable form and running using some form of computer readable memory. The computer program can be stored on a non-transitory storage medium. An element can be implemented using software, hardware, or combinations thereof. An element can be implemented across multiple devices such as over a network (e.g., across devices in a network or across network cloud 101 and external devices). For ease of understanding, individual functional elements are described herein; however, in application, elements can be integrated, can overlap, or can be divided in smaller elements. An element or portions of an element can be implemented over network cloud 101 and network cloud 101 can be configured to selectively or automatically increase computer resources for that element so that it adapts and increases data or processing capabilities. Network cloud 101 can be implemented to specify an amount of data or processing capability that is assigned to a service provider such as to an element that is assigned to support the service provider. Network cloud 101 can selectively or automatically escalate data or processing resources for that element so as to, for example, adapt to an increase in the need for the element. This can, for example, be implemented to match a spike in the business of one or more service providers so that they can increase and maintain those resources.

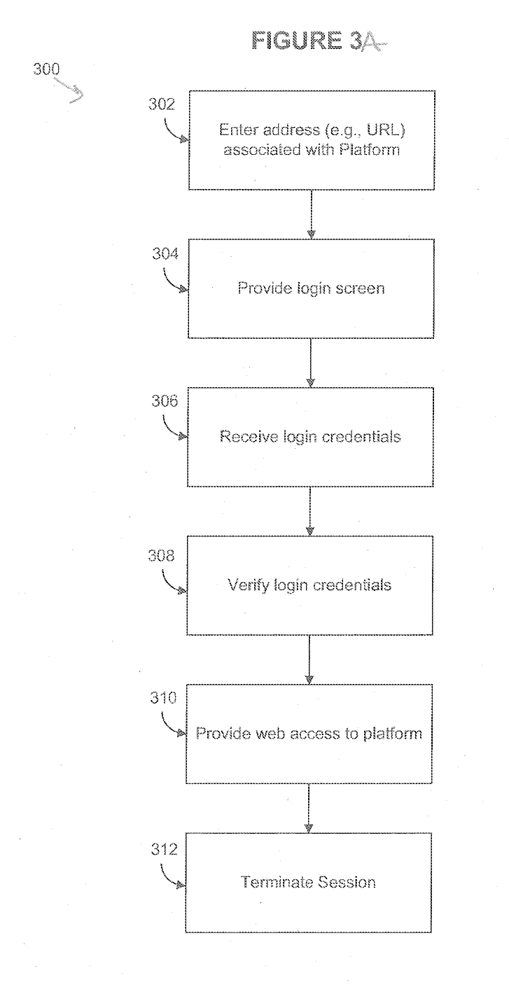

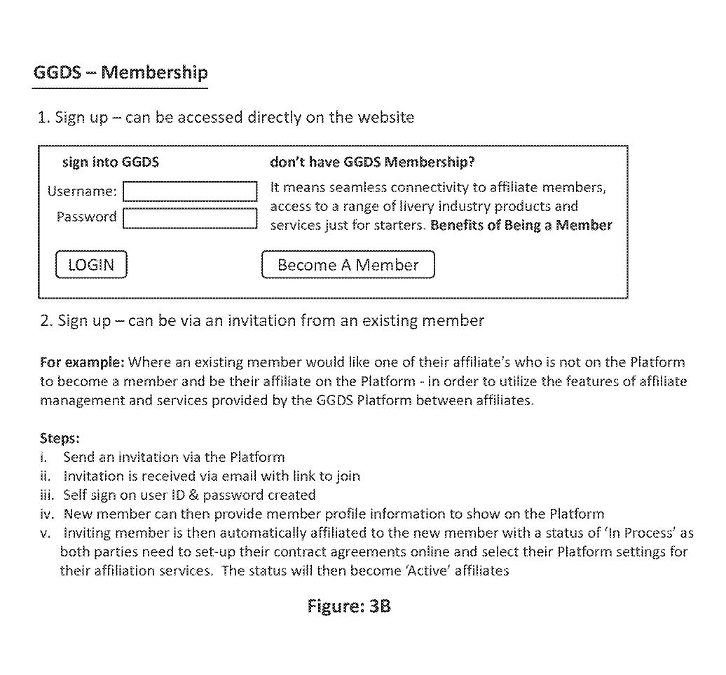

The term data is sometimes used herein to include one or more of the following: information, database entries, data for supporting software applications, multimedia files, other types of files, graphics, images, software, selectable resource options, and software modules. Web Interface Element 202 may be implemented to handle access to the business platform 206 to or from service providers using a web browser, such as through computer 120. Web Interface Element 202 may be implemented using a web server system, such as an Apache Web server. These web server systems may be further configured with sub-systems for adapting the web server system to provide additional functionality to web browsers, such as XML, Java, and SSL services. As shown in FIG. 3A, a process 300 for accessing the platform 200 via the Web Interface Element 202 may be implemented. At Step 302, the service provider may launch a web browser and enter a URL associated with the platform 200. Alternatives to URLs may also be entered, such as entering an IP address or any other form of address information. In some embodiments, Step 302 may be performed by software, such as a script that enters the URL when the web browser is launched. Step 302 may also be performed by a dynamic crawler. At Step 304, the Web Interface Element 202 may be implemented to initiate a web session from a web browser directed to that URL or other suitable address. In one embodiment, the Web Interface Element 202 will present a login screen for the platform 200, an example of which is shown in FIG. 3B. In some embodiments, however, a log-in may not be immediately presented, but rather may be accessible from the web page provided by the Web Interface Element 202. At step 306, the service provider may submit login credentials via the login screen. In alternative embodiments, Step 306 may performed by software, such as a script that enters the login credentials when the login screen is presented. At Step 308, the Web Interface Element 202 may implement a process for verifying the login credentials, such as looking up a username and password in a user database. If the login credentials are invalid, the Web Interface Element 202 may re-present the login screen or terminate the session. At Step 310, if the login credentials are validated, the Web Interface Element 202 may then provide access to various features of platform 200. At Step 312, the Web Interface Element 202 may be implemented to terminate the session providing the service provider access to the platform. For example, a logout may have been requested or a timeout may have been triggered due to user inactivity.

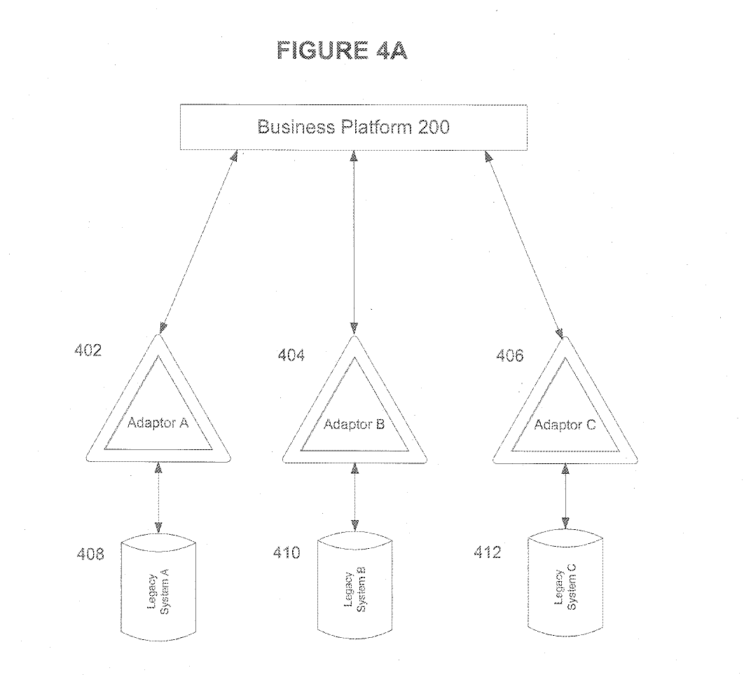

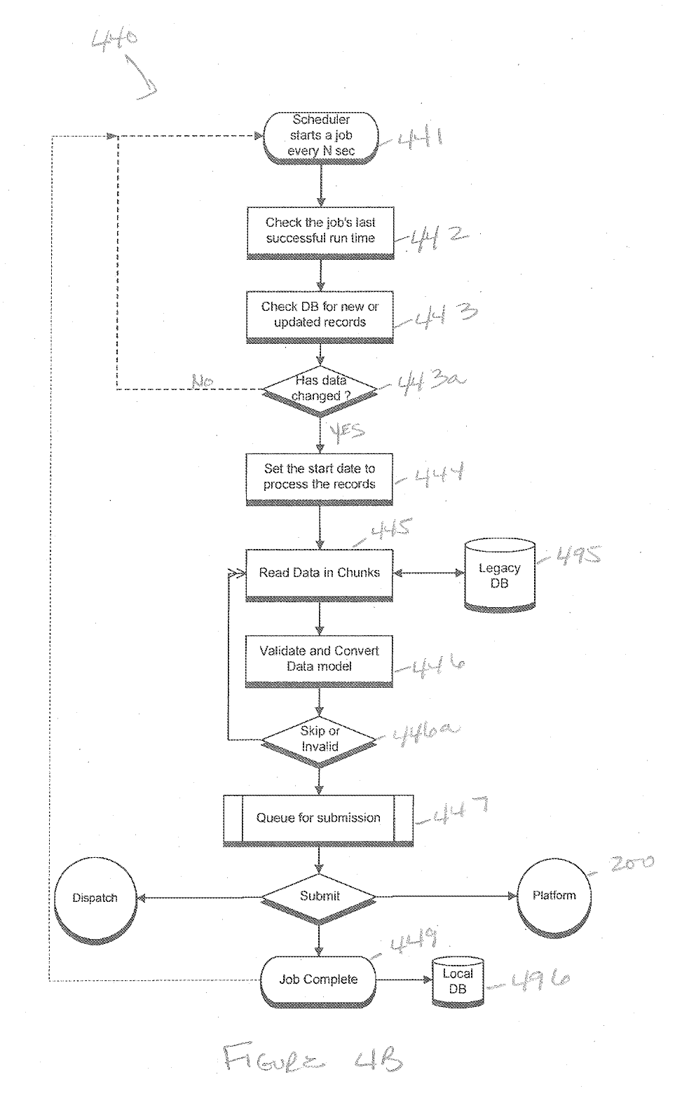

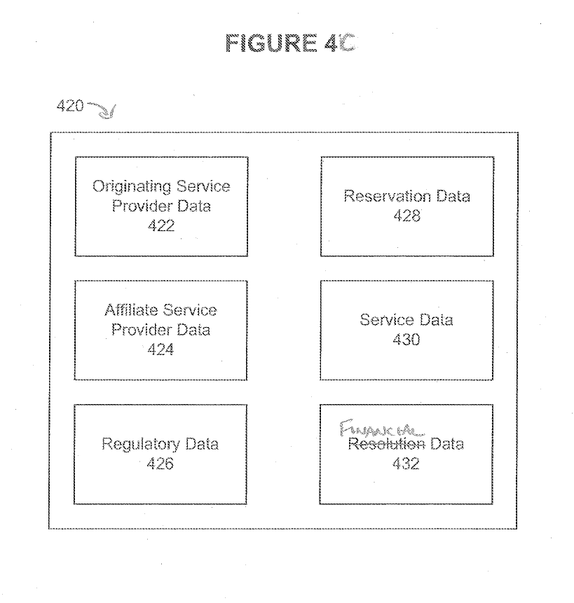

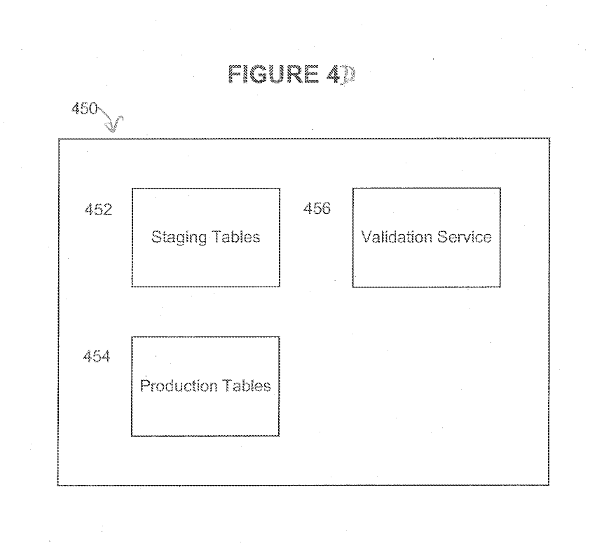

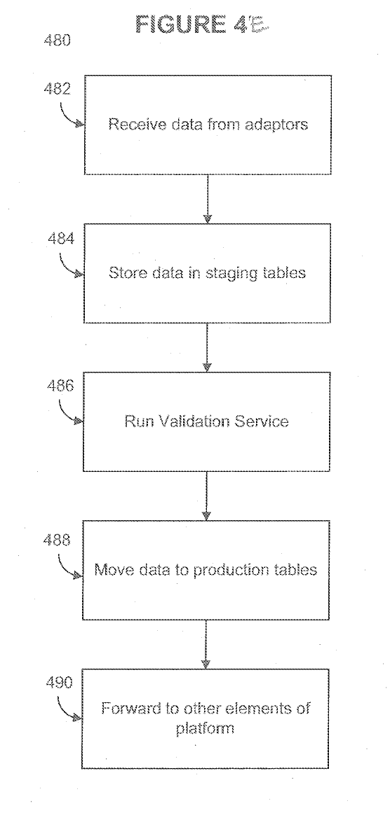

Adapter Interface Element 204 may be implemented to handle access to or from the business platform 200 from one or more adapters 116. An example of adapters 116 in use with an embodiment of the presently disclosed system and method is shown in FIG. 4A. Some service providers may use one or more legacy systems 118 for handling portions of their day-to-day operations, such as vehicle inventory management, which they may prefer to continue using even though such functionality is available on platform 200. In such situations, it may be preferable to configure an adapter that can ensure that information (e.g., vehicle inventory, schedules, historical performance data, etc.) on a legacy system 118 is kept current with information on the business platform 200 (or vice versa). As service providers may use different legacy systems, different adapters may be implemented for each legacy system or possibly even each service provider. One or more adapters can obviate the complexity of data transmission between legacy systems since an adapter has a repeatable architecture where the connection points between system are always the same. An adaptor enables asynchronous transfer of data between legacy systems and business platform 200, and the adapter is able to remain running when an associated legacy system becomes unavailable (e.g., due to hardware failure or software crash). As an example, in FIG. 4A, it is shown how Legacy System A utilizes Adapter A, Legacy System B utilizes Adapter B, and Legacy System C utilizes Adapter C to reach the Adapter Interface Element 204. Adapter A reads data from Legacy System A, transforms it into a known Industry Standard Data Model (ISDM) and sends it via a web services call to business platform 200. The platform forwards this message to Adapter B, and Adapter B converts the standard data model into a new data model that Legacy system B is expecting. Adapter B functions in a similar manner relative to Adapter C.

Adapters use a queuing technology to resume bi-directional data transmission at the exact point where a transmission failure is detected. For example, data being exchanged to/from Adaptors A, B and C will be stored in database staging tables 452 (see FIG. 4D) where a validation service will be executed against that data. When the data passes the validation checks, it will then go into production tables. When the data does not pass validation, it will be marked as incomplete. The incomplete data will be reviewed and corrected in order to successfully pass the validation checks and go through the production tables. This process is further described with reference to FIG. 4B, which shows a process 440 for transmitting data (included updated data). The process initiates at 441 when a scheduler starts a job having one or more associated tasks (e.g., updating fleet inventory, updating dispatch information, etc.). The scheduler is a time-based controller that enables jobs to run periodically (e.g. continuously, or at certain times and/or on certain dates). At Step 442, the job's last run time is checked, thereby ensuring that any interruption of a legacy system will not adversely impact data transmission. At Step 443, a legacy database 495 is checked for new or updated records. At decision point 443a, if the data remains unchanged, process 440 returns start again at 441. If the data has changed, process 440 proceeds to Step 444 at which the start date is set for processing the new and updated records. At Step 445, the data is read, and in some embodiment is read in chunks in order to increase the read/write performance through the adapter. For example, if a database has 100 affiliate record that need to be loaded into business platform 200, this data is broken down into 10 groups of 10 records each (wherein each group is designated a “chunk”). At Step 446, the data is validated and converted into a data model (such as ISDM). At decision point 446a, if the data does not pass validation, the process returns to Step 445 for review and correction. If the data does pass validation, at 447 the data is queued for dispatch and/or submission to business platform 200. As the process completes at 449, the submitted data can be stored in a local database 496 and correspondingly reconciled with data in legacy database 495.

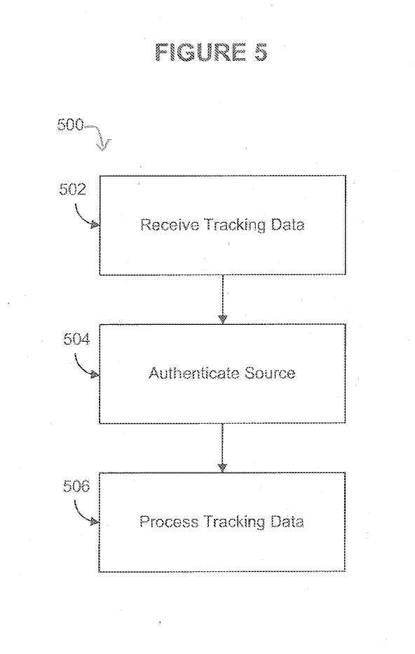

While the communications between adapters 116 and the legacy systems may vary, it may be desirable that the communication between the adapters follows a standardized format 420 as shown in FIG. 4C. In this manner, the burden of interacting with legacy systems is not placed upon the Adapter Interface Element 204, but rather on the adapters 116. With respect to FIG. 4C, the standardized format 420 may be implemented to contain Originating Service Provider Data 422, which may provide information about the service provider that booked service with an affiliate service provider. The standardized format 420 may also be implemented to contain Affiliate Service Provider Data 424, which may provide information about the affiliate service provider that provided service on the behalf of the originating service provider. The standardized format 420 may also be implemented to contain Regulatory Data 426, which may provide information about the affiliate relationships between the originating service provider and the affiliate service provider. The standardized format 420 may also be implemented to contain Reservation Data 428, which provides information regarding the services that the originating service provider booked with the affiliates service provider (e.g., vehicle type, geographic location, length of time). The standardized format 420 may also be implemented to contain Service Data 430, which provides information regarding how the services were performed by the affiliate service provider. The standardized format 420 may also be implemented to contain Financial Data 432, which provides financial information on billing, payment, and other financial activities related to the booking. It is to be understood that the standardized format 420 may be implemented with only a portion of these elements described above. In addition, the standardized format 420 may also be implemented to contain other information beyond those described above. In some embodiments, the standardized format 420 may be used for other purposes than communicating between adapters. For example, in one embodiment, the standardized format 420 may be used for a Reservation Transaction Object in the Reservation Transaction Object Database 236 of FIG. 2. Adapter Interface Element 204 may be implemented using secure SSL (Secure Socket Layer) or other encryption protocols and mechanisms. The Adapter Interface Element 204 may also be implemented using components such as a gateway 450 shown in FIG. 4D to perform process 480 shown in FIG. 4E. With reference to FIG. 4E, process 480 begins at Step 482 in which the Adapter Interface Element 204 may receive data coming from the adapters 116. At Step 484, the Adapter Interface Element 204 may be configured to store the received data in staging tables 452. At Step 486, a validation service 456 may be implemented to run checks on the data (e.g., authentication, error correction). If the data passes the validation checks, the data may then be moved into production tables 458 as shown in Step 488. If the data does not pass validation, it may be marked as incomplete or rejected. The Adapter Interface Element 204 may then forward data placed into production tables 454 to other elements in platform 200. It is understood that in order for the adapters to perform this process, the adapters may be a hardware device and/or software component that converts transmitted data from one presentation form to another. The adapters may include computer-processing devices, memory, storage, network access, software, or other computer-related elements. Process 480 may complement process 440 described above with reference to FIG. 4B. Tracking Interface Element 206 may be implemented to handle access to the business platform 200 to or from one or more network-enabled geographical positioning devices (e.g., GPS). Tracking Interface Element 206 may be implemented using a variety of protocols, including but not limited TCP/IP or Ethernet. In some embodiments, service providers may install geographically-aware network-enabled devices to track vehicles (e.g. a GPS data location transmitter). Such devices may be implemented with limited functionality, such as only sending tracking data that may enable the platform 200 to locate the vehicle on a routine basis. As shown in FIG. 5, the Tracking Interface Element 206 may implement process 500 by beginning at Step 502 by receiving tracking data, such as from a GPS-enabled network device in a vehicle. Upon receiving the tracking data, the Tracking Interface Element 206 may then use information in the tracking packet to authenticate at Step 504 if the tracking data was sent by an authorized device or if the device is associated with a particular vehicle. If the authentication is successful, the Tracking Interface Element 206 at Step 506 will then process the tracking data and forward the results to other elements in platform 200. In one embodiment, the Tracking Interface Element 206 may send the results on a varying, periodic, or continuous basis to Reservation Element 222 to update a Reservation Transaction Object Database 236 with the status of a vehicle, such as shown in Table 1, when the vehicle is providing service on the behalf of one service provider to another service provider:

TABLE 1
Status of Vehicle

1 - Driver in Vehicle
2 - Vehicle En-Route to Pick Up Location
3 - Vehicle arrived at Pick Up Location
4 -Passenger in Vehicle
5 - Passenger Drop Off
6 - No Passenger in Vehicle
7 - Scheduled Passenger Stop
8 - Unscheduled Passenger Stop

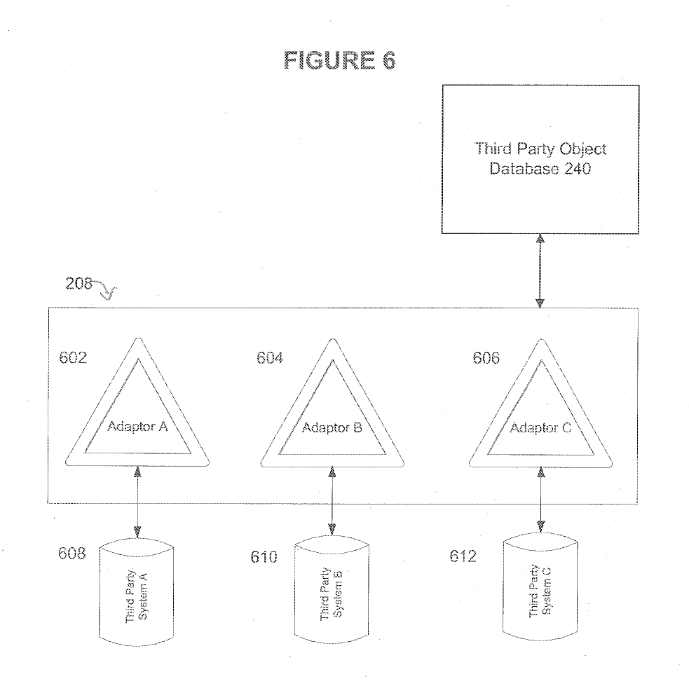

Third Party Interface Element 210 may be implemented to handle access to the business platform 200 to or from third-party systems. Third Party Information Database 240 may also be implemented to store information received from third-party systems. Third Party Interface Element 210 may be implemented in a fashion similar to Adapter Interface Element 204. However, third party systems such as Sabre (GDS), Apona, and SITA may not wish to use adapters 116 at their facilities. In this situation, such adapters may be instead implemented as part of the Third Party Interface Element 210 as shown in FIG. 6. This implementation allows the Third Party Interface Element 210 to handle interactions with third-party systems that do not wish to use adapters 116 at their facilities.

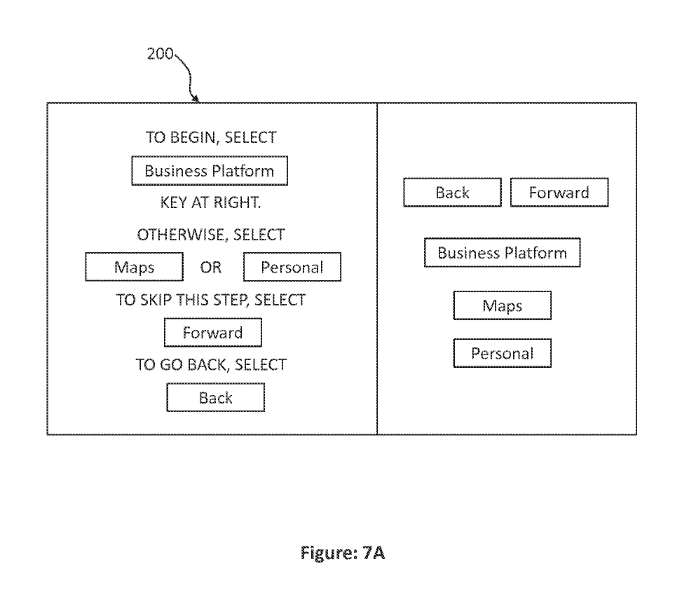

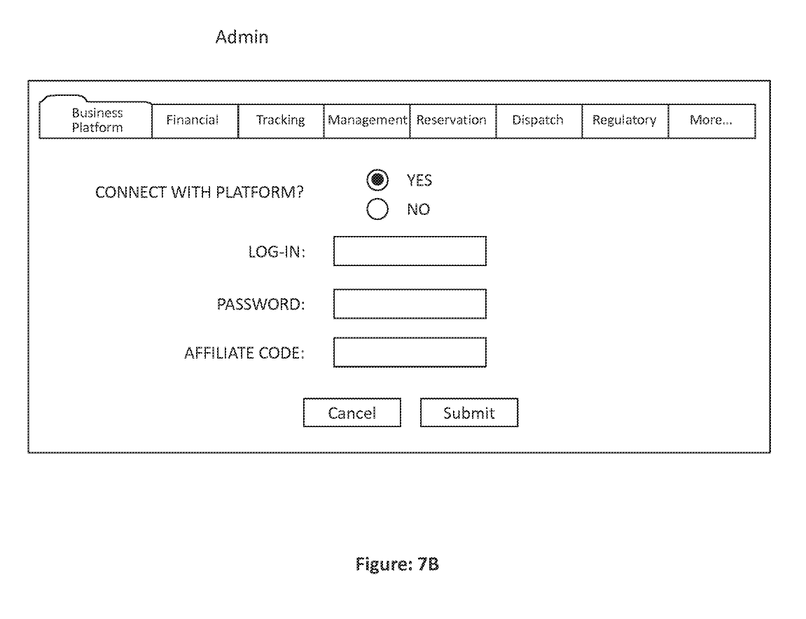

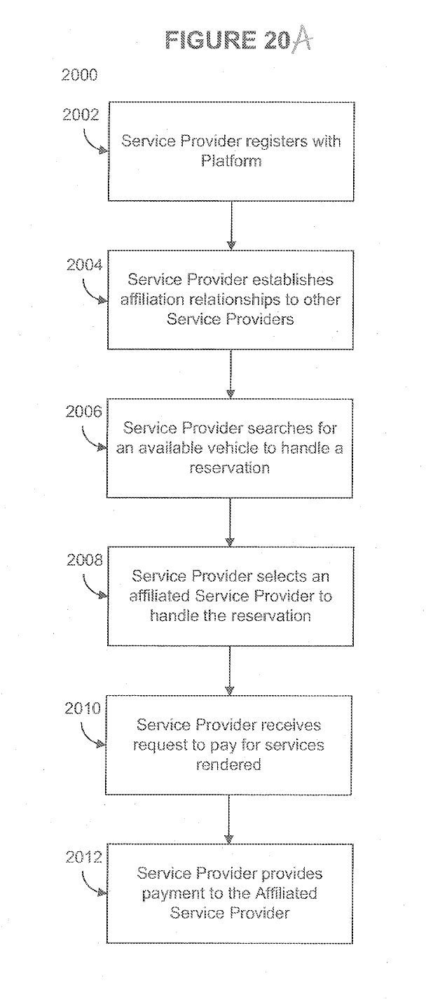

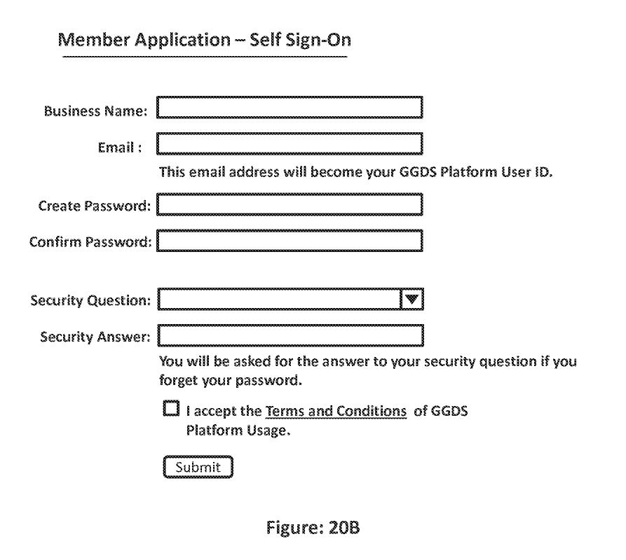

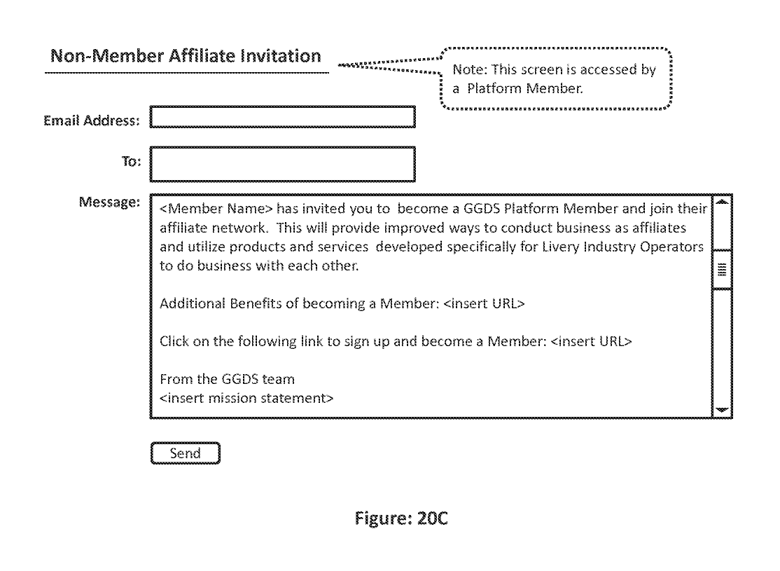

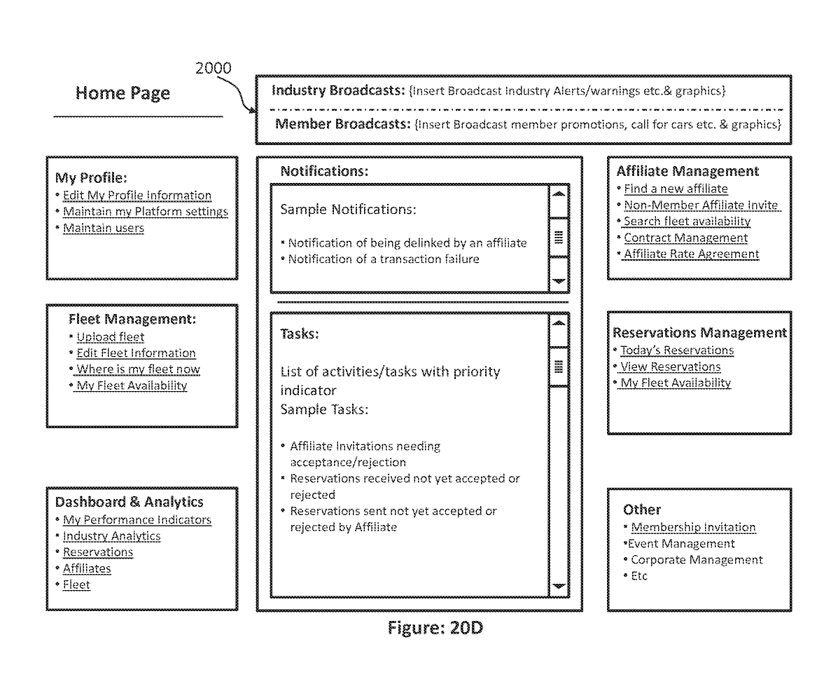

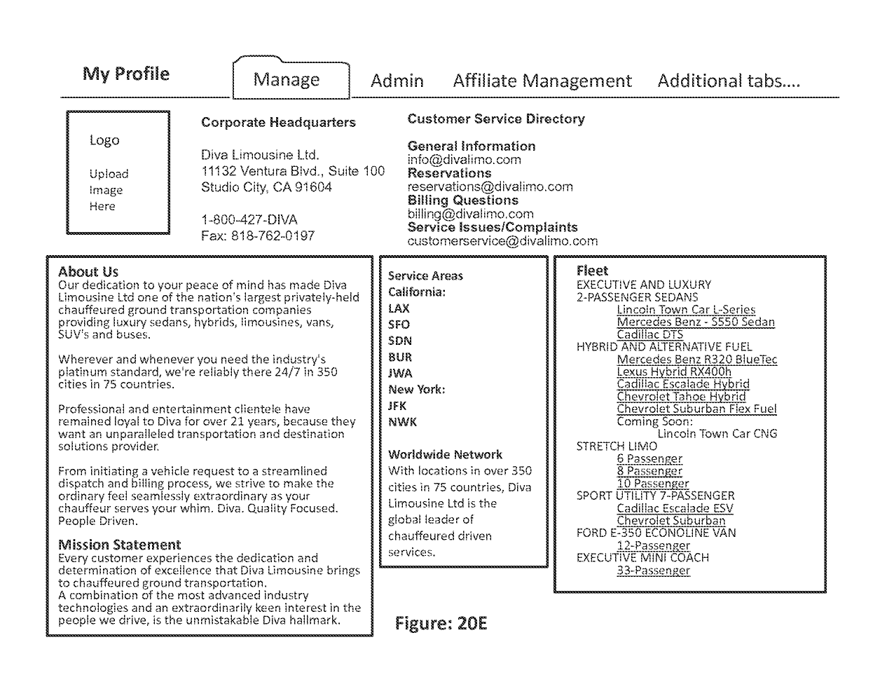

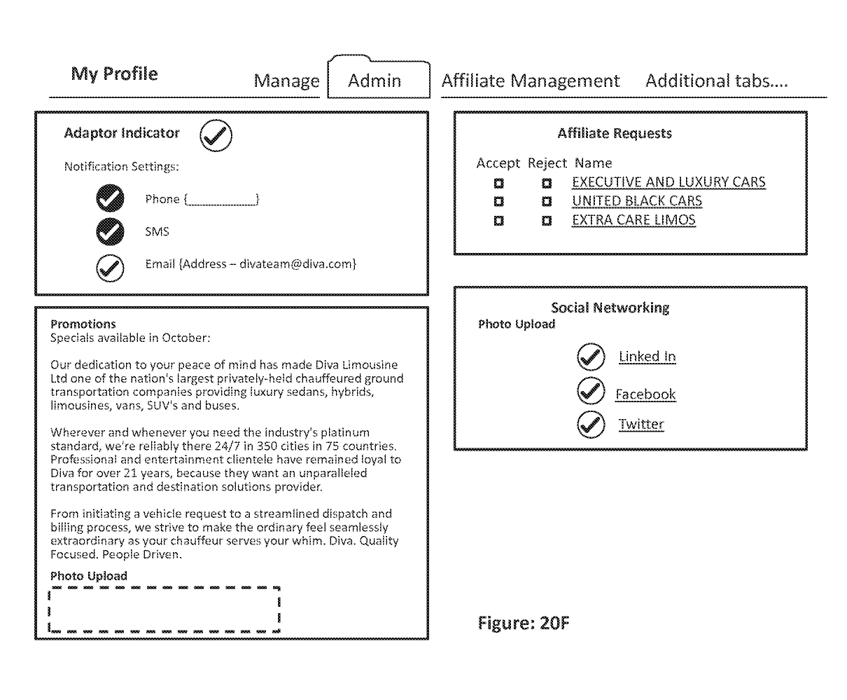

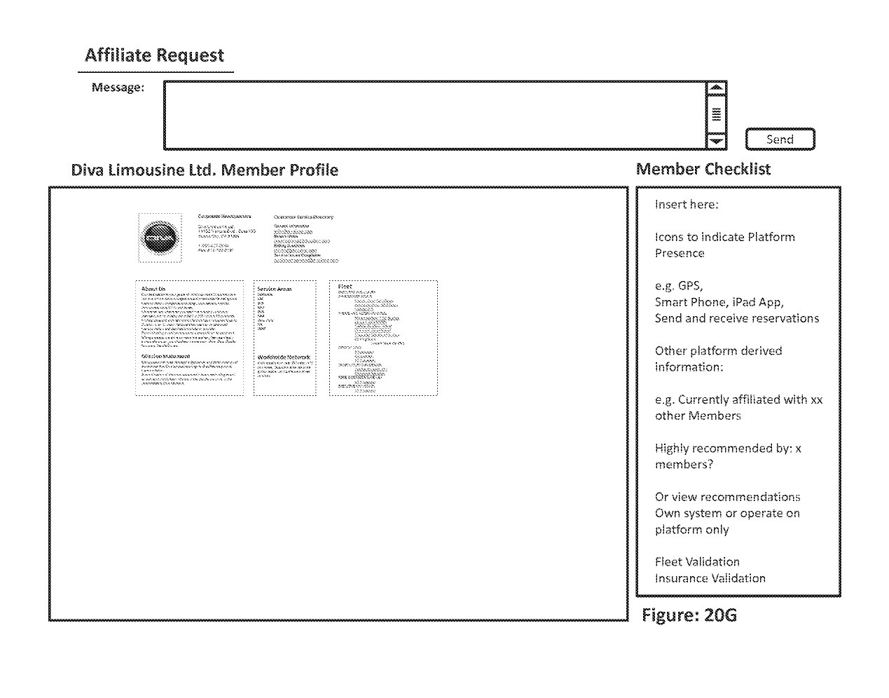

Applet Interface Element 208 may be implemented to handle access to the business platform 200 to or from one or more applets designed for tablets and equivalent and complementary devices. As shown in FIG. 7A, an illustrative applet 700 can be used to manage access to business platform 200 as well as to engage with the platform's numerous interface elements. Applet 700 may be implemented via a web browser or directly supported by an operating system. Applet 700 can be used to view basic information about business platform 200, such as data regarding the platform's ownership, technical requirements and any copyright notices. As shown in FIG. 7A, selection of “Business Platform” (designated by a “BUSINESS PLATFORM” key) can launch applet 700 and/or one or more corresponding applets. Applet 700 may also be used to access other applets, such as a maps applet (designated by a “MAPS” key) that can allow access to pre-loaded maps, including but not limited to maps of often-used transportation routes, alternative transportation routes, routes among common landmarks and the like. Applet 700 may also be used to access a personalized applet (designated by a “PERSONAL” key) that can allow access, synchronization and updating of an operator's “Home Page” (as further shown and described below with reference to the example shown in FIG. 20B) or individual data (for example, an independent operator's earnings over a set time period, a corporate operator's negotiations with independent operators, an operator's return on investment for purchased vehicles, etc.). Applet 700 can allow operators to selectively integrate personally collected data with, or keep such data separate from, business platform 200. Such selectivity allows operators to maintain uploadable records for private reconciliation of data apart from the affiliates who access business platform 200. This feature also allows the operators to beneficially upload data as desired to the platform for ready access by all affiliates. For example, an operator may wish to use the “MAPS” applet to upload maps of common alternative routes to a local airport to its affiliates, particularly if the affiliates do not transport customers to the airport very often. Such affiliates may know the main route but may not know the local access roads in the event the main route is subject to delays. Such shared knowledge benefits the entire community of operators. The same operator, however, may not wish to upload the mapped routes for all of the operators' clients, particularly if the operator is under a directive to preserve a client's privacy and therefore does not wish to share a particular client's pick-up information.

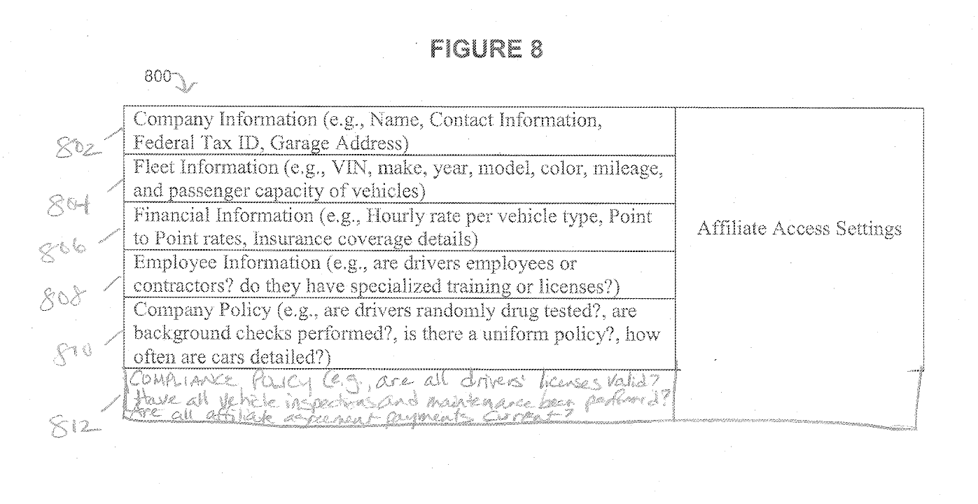

Applet 700 can also cooperate with a web interface element such as Web Interface Element 202 to manage access to business platform 200. As shown in the example of FIG. 7B, a web interface element may implement a process for verifying login credentials, including but not limited to confirming that the user wishes to access the business platform, requiring the user to enter a log-in ID and/or password and optionally requiring a user to enter an affiliate code. Entry of affiliate codes may assist in the automated differentiation among transportation providers. For example, a service provider having an affiliate code beginning with an “A” can automatically be recognized by the system as approved to provide service to A-list and special needs clients, while an affiliate code beginning with a “Z” may designate a bottom tier service provider approved only for the most basic assignments. It is understood that correspondence of affiliate codes with permitted levels of service is arbitrary, and the use of affiliate codes is optional. If the log-in credentials are valid, applet 700 may be used to manage synchronization activity among various interface elements of business platform 200 as shown in FIG. 7B. The interface elements can include various options including but not limited to Financial Element 205. Tracking Interface Element 206, Management Interface Element 212, Reservation Interface Element 214, Dispatch Interlace Element 218, Regulatory Element 224 and other options (as designated by the “MORE . . . ” key in FIG. 7B). Applet 700 is provided as only an example, and it is understood that applet interlace element 210 can be customized as desired to provide applets of desired functionality and form for any provider and/or any community of providers as needed. Management Interface Element 212 may be implemented to allow a service provider. to manage information about their company and its resources on the platform 200. As shown in FIG. 8, the platform may be implemented to allow each service provider to enter a variety of information types, including but not limited to: company information 802, fleet information 804, financial information 806, employee information 808, and company policy 810. In addition, regulatory settings 812 may be implemented for any of this information. This information provided by the service provider may be stored in Service Provider Specific Database 234 as part of platform 200.

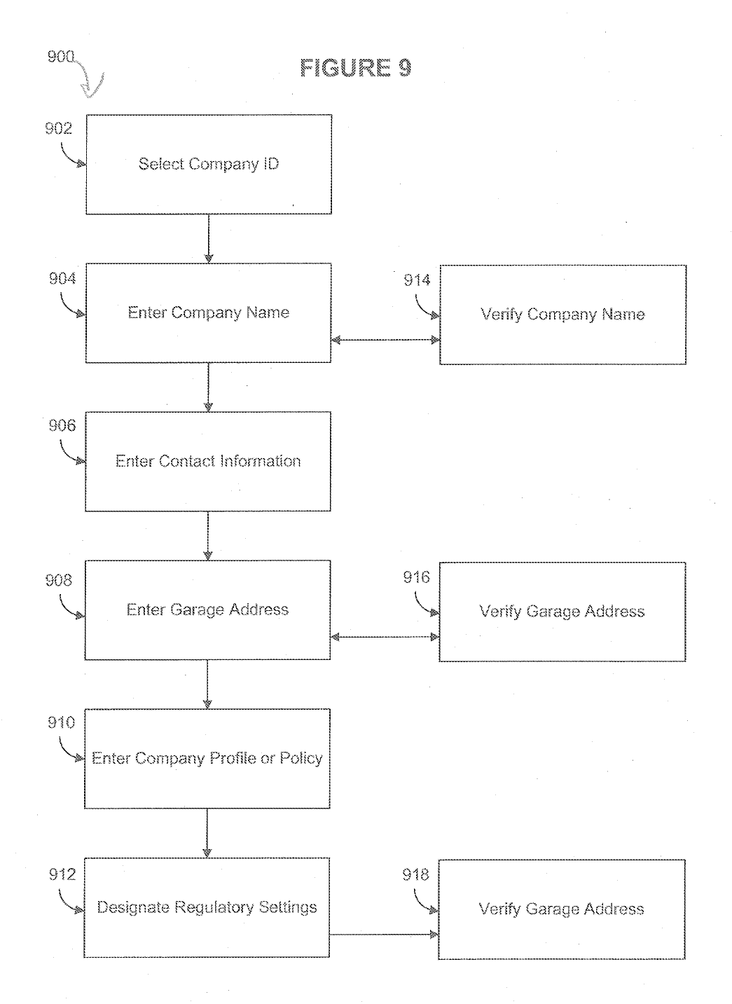

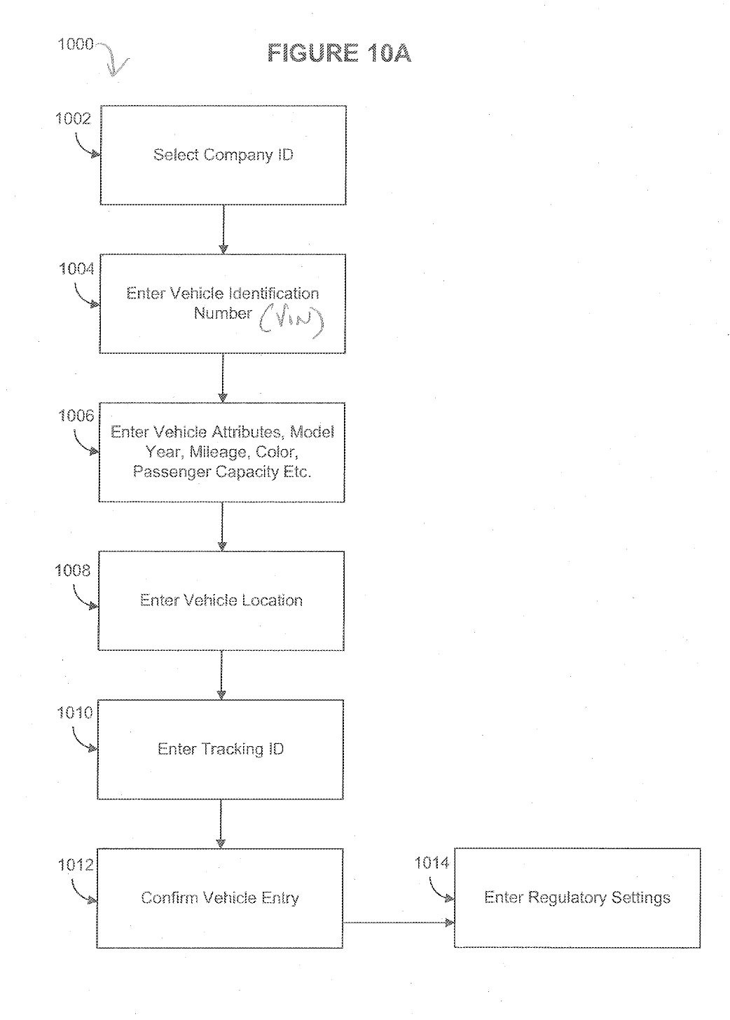

With reference to FIG. 9, a service provider may enter company information using process 900 in the Management Interface Element 212. As service providers may operate multiple companies, at Step 902 a selection process may be implemented for the service provider to select a company ID. The Management Interface Element 212 may also be configured to retain this selection and provide it automatically for similar requests until the service provider de-selects the company ID. At Step 904, the service provider may enter the name of the company. At step 914, the Management Interface Element 212 may seek to verify the company name, such as ensuring that it meets acceptable rules or that it is not duplicative of other company names possessed by other service providers. In addition, the Management Interface Element 212 may also perform further checks by utilizing the Validation Interface Element 220 or Validation Element 226, described herein, such as to confirm the existence of the company or to retrieve records associated with the company. At Step 906, the service provider may enter contact information associated with the company. At Step 908, the service provider may also enter a garage address where the vehicles are stored or serviced. In association with Step 908, the Management Interface Element 212 may also implement Step 916 to ensure that the garage address provided is valid or associated with the company. This step may include cooperation with Third Party Interface Element 210 and/or Third Party Information Database to search, for example, a Secretary of State's records of incorporation. At Step 910, the service provider may enter the company profile, which may provide a general explanation of the company's history, service area, or services. As part of the Management Interface Element 212, other general information about the company may be stored about the company, which may also include the verification of such information by the platform. At Step 912, the Management Interface Element 212 may be implemented to provide service providers with the ability to designate regulatory settings for controlling access to the company information that has been recorded. Validation element 226 can be configured to determine or confirm that a service provider has sufficient business or operational requirements such as a threshold requirement for being permitted on the platform or a threshold requirement, which when met, permits a service provider to use the platform or accept reservations from another service provider. Validation element 226 may also be implemented on the platform to permit the platform to send a message or other notification to a service provider or the service provider's affiliate that a business or operational requirement needs to be updated, renewed, certified, or granted because, for example, it is out of date or a third party resource provided data that the there is some lack of compliance with a statutory and/or contractual requirement (e.g., suspension or expiration of a license or permit that may trigger termination of an affiliation agreement). Validation element 226 can also be implemented to send a message or other notification when an upcoming validation deadline is coming up. Validation element 226 can also be implemented to operate with the platform to send a message or notification such as a visual alert when a service provider is interacting with the platform to, for example, select an affiliated service to handle a reservation. For example, validation element 226 can display a visual notification or send such a notification to be displayed when a service provider is not in compliance (or nearing non-compliance) and another service provider is viewing information related to that service provider. This is so that, for example, a requesting service provider can know (visually notified) that an affiliate that can handle a reservation (e.g., when viewing a search result) is not in compliance or has some validation problem that needs to be addressed. When searching for affiliates, validation element 226 can interact with other elements to reduce or eliminate placement of a service provider when that service provider has received a negative output (e.g., non-compliance with regulatory and/or platform requirements, or non-compliance with a service provider's requirements as contractually set out with its affiliate) from validation element 226. Regulatory settings are used in variety of instances in conjunction with the Regulatory Element 224. Their purpose is to assist the Regulatory Element 224 in implementing the electronic constraints on the use of information in the platform. For example, a service provider may designate the information stored by the Management Interface Element 212 as available only to the service provider, the service provider's affiliates, specified groups of service providers, anyone using the platform, etc. Any such designation can be automatically determined by recognition of a user upon login (for instance, by entry of an affiliate code such as described above with respect to FIG. 7B). The regulatory settings may also be implemented to address dynamic changes on the platform, such as when relationships between service providers change, when booking volume approaches a threshold (e.g., only providing certain information if there is a substantial volume of business between the service providers), when affiliation agreements are entered into, amended, enforced and/or terminated (e.g., an affiliate service provider may change its affiliate relationship with one of its own affiliates, such that the service provider is now able to exchange information with the secondary affiliate), or when affiliates change various information (e.g., changes in geographic location, participation in rewards programs, commitment to specialized programs such as services for disabled passengers and green vehicle program, etc.). With reference to FIGS. 10A and 10B, a service provider may enter vehicle information using process 1000 in the Management Interface Element 212. As service providers may operate multiple companies, at Step 1002 a selection process may be implemented for the service provider to select a company ID. The Management Interface Element 212 may also be configured to retain this selection and provide it automatically for similar requests until the service provider deselects the company ID. At Step 1004, the service provider may enter a vehicle identification number (VIN) associated with a vehicle used for livery service. At Step 1006, the service provider may enter information about various characteristics about the vehicle, including the model, year, color, mileage, or passenger capacity of the vehicle. At Step 1008, the service provider may enter the service area covered by this vehicle, such as an airport code, a metropolitan area, zip codes, or other geographic identifiers. At Step 1010, the service provider may enter a tracking ID associated with the vehicle. For example, this tracking ID may be a nickname for the vehicle (e.g., “Buick-2”). In other embodiments, the tracking ID may be associated with a tracking device located in the vehicle that interacts with the Tracking Interface Element 206. In addition, a vehicle may not be associated with only one tracking ID, as in some implementations the Management Interface Element 212 may allow for the tracking ID to consist of multiple identifiers, such as where the platform uses such identifiers to serve different purposes.

At Step 1012, the Management Interface Element 212 may also perform further checks by utilizing the Validation Interface Element 220 or Validation Element 226 to confirm the vehicle information or to retrieve records associated with the vehicle. At Step 1052, the Validation Element 226 may receive a VIN from the Management Interface Element 212. At Step 1054, the Validation Element 226 may then decode the VIN to receive information about the characteristics of the vehicle, such as vehicle type, engine size, etc. At Step 1056, the Validation Element 226 may check that vehicle attributes provided to the Management Interface Element 212 were correct. At Step 1058, the Validation Element 226 may check that the vehicle year provided to the Management Interface Element 212 was correct. To avoid the use of duplicate vehicle identification numbers, such as where a service provider shares vehicles across multiple corporate entities, at Step 1060 the Validation Element 226 may check that there are no duplicate vehicle identification numbers. At Step 1062, if the Validation Element 226 has not encountered any problems with the VIN, it will inform the Management Interface Element 212 that the VIN is valid and the associated vehicle information is correct. If the Validation Element 226 has encountered problems in the prior steps, it will inform the Management Interface Element 212 that the vehicle entry is invalid. In some embodiments, the Validation Element 226 may inform the Management Interface Element 212 of the error encountered. At Step 1014, the Management Interface Element 212 may be implemented to provide service providers with the ability to designate regulatory settings on the vehicle information that has been recorded (e.g., whether the vehicle registration is up to date, whether all requisite maintenance and inspections have been performed, etc.). Validation element 226 can include or incorporate data from a VIN decoder software or system (not shown). A VIN decoder provides a tool for decoding a vehicle identification number. A VIN decoder can translate the identification number and identify the type, model, color, or other vehicle characteristics. VINs are codes that are generated by a vehicle manufacturer that can be used to confirm the existence and characteristics of a vehicle. Third party issued details such as a VIN number can be used to obtain or retrieve other vehicle information from third party sources. This data can be used to confirm quality, reservation inventory, or other factors. Implementing such decoder features can assist in the affiliation platform, such that an affiliate may condition making its own specific data (e.g., second portion data) available when data has been provided by a counter service provider and verified such as through the operation of one or more decoder or validation operations.

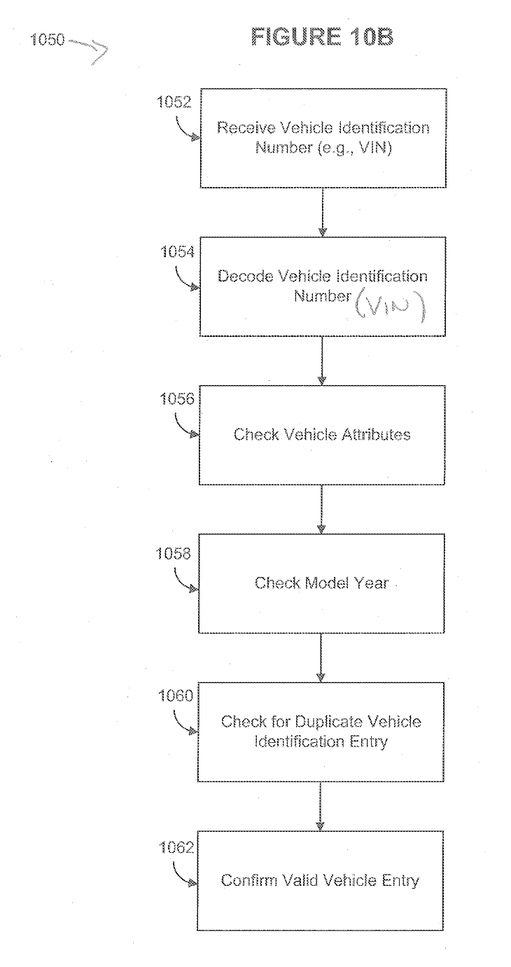

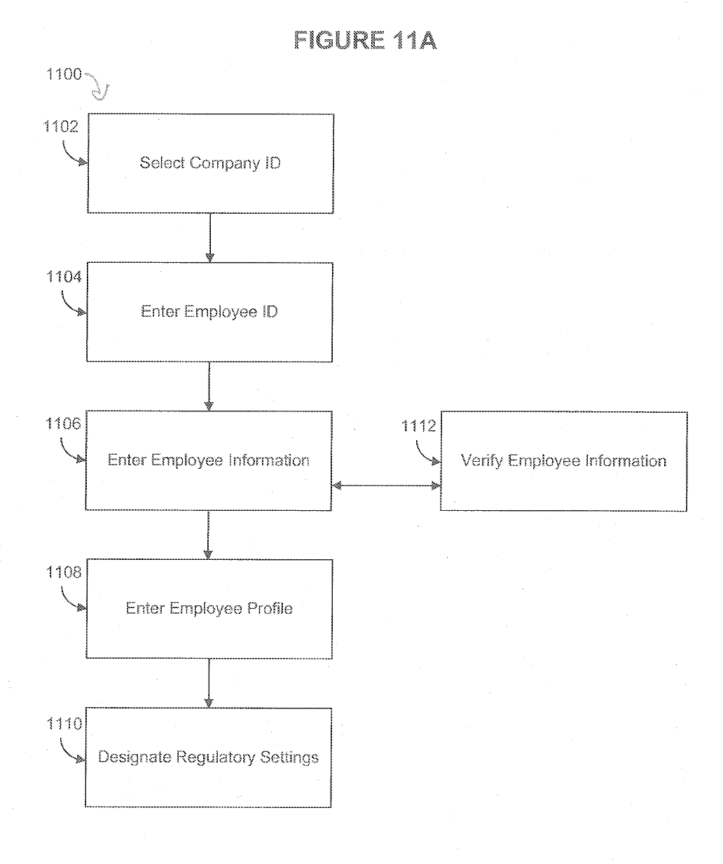

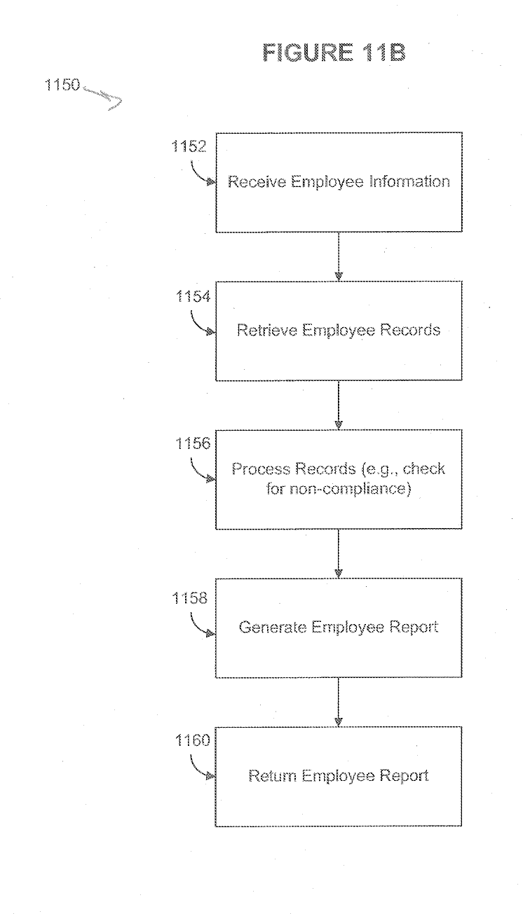

With reference to FIGS. 11A and 11B, a service provider may enter employee information, such as regarding chauffeurs or drivers, using process 1100 in the Management Interface Element 212. As service providers may operate multiple companies, at Step 1102 a selection process may be implemented for the service provider to select a company ID. The Management Interface Element 212 may also be configured to retain this selection and provide it automatically for similar requests until the service provider de-selects the company ID. At Step 1104, the service provider may enter an employee ID associated with the employee. At Step 1106, the service provider may enter information about various characteristics of the employee, including driver's license number, gender, experience, criminal record, credit report, moving violations, contractor status, specialized training, or other information. At Step 1106, the Management Interface Element 212 may also perform further checks by utilizing the Validation Interface Element 220 or Validation Element 226, described herein, to confirm the employee information or to retrieve records associated with the employee. As shown in FIG. 11B, beginning with Step 1152, the Validation Element 226 may receive employee records (e.g., driver's license number) from the Management Interface Element 212. At Step 1154, the Validation Element 226 may then utilize the driver's license number to retrieve a driving abstract (or similar or complementary record of driver performance) from a third party system through the Third Party System Interface Element 210. In some instances, interacting with third party systems to retrieve such records may require use of the Validation Interface Element 220. For example, accessing an individual's driving abstract may require that the employee interacts with certain elements of a local Department of Motor Vehicles. In other instances, the validation element or compliance element 226 may have the requisite information on the platform 200 or can be configured to interact with third party systems without use of the Validation Interface Element 220. At Step 1154, the Validation Element 226 may process the records retrieved, such as to determine if the employee's records meet certain criteria (e.g., a non-suspended driver's license, lack of DUIs, etc.) or to provide additional employee information (e.g., date of license expiration) not entered by the service provider. At Step 1156, the Validation Element 226 may then generate a report based on the information about the employee it has processed. At Step 1158, the Validation Element 226 then returns the employee report to the Management Interface Element 212. Returning to process 1100, at Step 1108, the service provider may enter an employee profile, which may provide a general explanation of the employee's skills or experience. At Step 1112, the Management Interface Element 212 may be implemented to provide service providers

with the ability to designate regulatory settings on the employee information that has been recorded.

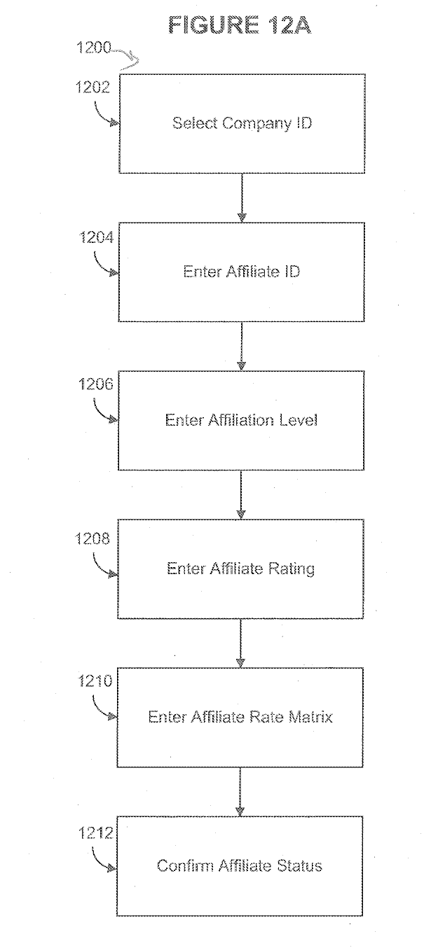

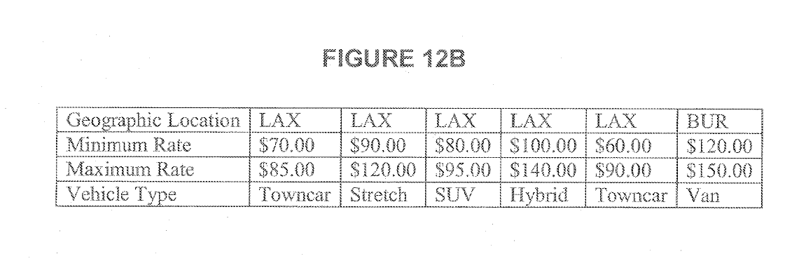

With reference to FIG. 12A, a service provider may specify affiliates, using process 1200 in the Management Interface Element 212. As service providers may operate multiple companies, at Step 1202 a selection process may be implemented for the service provider to select a company ID. The Management Interface Element 212 may also be configured to retain this selection and provide it automatically for similar requests until the service provider de-selects the company ID. At Step 1204, the service provider may enter an affiliate ID associated with the affiliate service provider (e.g., a company name, a unique code). At Step 1206, the service provider may enter information regarding the level affiliation between the service providers. For example, a service provider may divide its affiliates into first-level and second-level affiliates. It may also specify additional groupings of affiliates on the basis of other information, such as geographic location, participation in rewards programs, commitment to specialized programs (e.g., services for disabled and special needs customers, green vehicle programs, etc.). At Step 1208, the service provider may provide ratings regarding the affiliate service provider, such as overall score or scoring on various different metrics. At Step 1210, the service provider may enter a rate matrix showing its cost for hiring various types of vehicles as shown in FIG. 12B. For example, the rate matrix may specify minimum or maximum rates based on geographic location, vehicle type, date and time of service, or other relevant variables chosen between the service provider and the affiliate service provider. In addition, the rate matrix may be supplemented by point-to-point pricing (e.g., flat rate from JFK to Manhattan) or other exceptions to the rate matrix. At Step 1212, the Management Interface Element 212 submits certain aspects of the information entered about the affiliate to the platform for confirmation by the affiliate service provider. After the platform receives such confirmation, the information is confirmed and the affiliation status is activated.

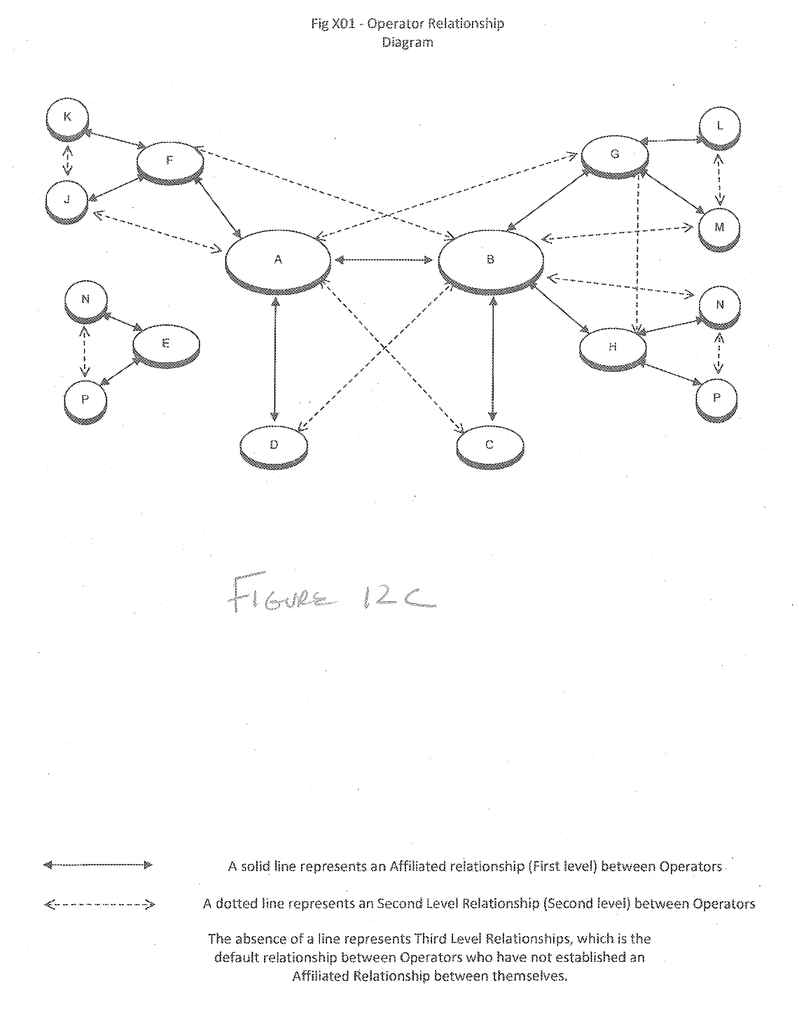

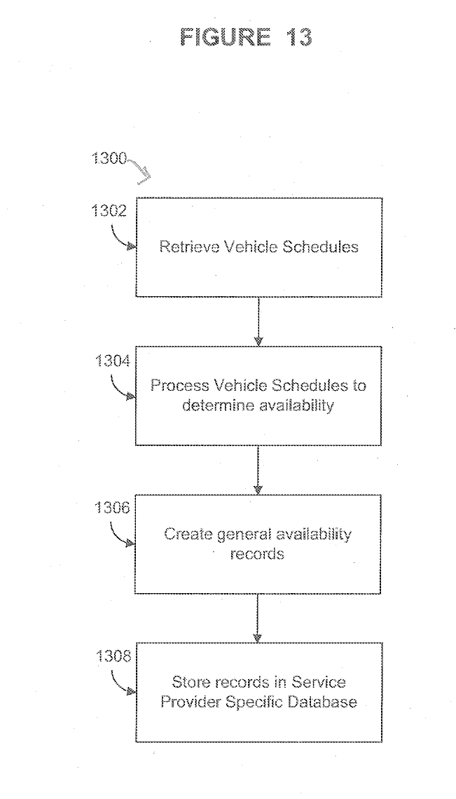

FIG. 12C shows an example of various affiliate relationships that may exist among various operators, shown as operators A, B, C, D. E, F, G, H, J, K, L, M, N and P. A solid line between operators (for instance, as shown between operators A and B, between operators A and D and operators B and C) represents an affiliate relationship between those operators. In an affiliate relationship (which may also be known as a “first level” relationship), two or more operators have entered into an affiliate agreement with one another to establish operational thresholds and boundaries (for instance, those that establish the behavior of the operators relative to each other). A dotted line between operators (for instance, as shown between operators and C, operators B and D, operators A and G and operators B and F) represents a “second level” relationship between those operators. In a second level relationship, services may be rendered on behalf of a service provider via a relationship with another service provider. For instance, operator A has a second level relationships with operators C and J via its first level relationships with operators B and F, respectively. Operator A may not wish to deal with operators C and J directly and may limit the information that operators C and J can access via business platform 200. The absence of a line between operators (for instance, as shown between operators A and E and between operators C and H) represents third level relationships between those operators. A third level relationship is the default relationship between operators who have not established an affiliated relationship between themselves. Therefore, the amount of information accessible between third level operators on business platform 200 will be minimal until the operators establish a higher level relationship. It is understood that the operator relationship shown in FIG. 12C is merely an illustration of the variety of operator relationships that can exist. It is also understood that any type of operator relationship is capable of designation by the presently disclosed system and method. For example, an affiliate code entered at applet 700 (shown and described above with respect to the example of FIG. 7B) can immediately identify a service provider as being in a second level relationship with another specified service provider. With reference to FIG. 13, business platform 200 may be implemented with an availability engine 228. Availability Engine 228 may review the Service Provider Specific Database 234 (shown in FIG. 2) to determine the availability of vehicles registered with the platform. For example, at Step 1302 the Availability Engine 228 receives a schedule for each vehicle indicating when the vehicle is reserved. The schedule may also include the travel plan for the vehicle. At Step 1304, the Availability Engine 228 processes the schedules for the vehicles to determine when such vehicles are not in use. In addition, it may make determinations regarding other aspects of the vehicle's availability. For example, if the schedules include a travel plan, the availability may also be determined using the expected geographic location of the vehicle at the start or end of its scheduled event. At Step 1306, the Availability Engine 228 may process the information to provide records of generally availability for a service provider. For example, the Availability Engine 228 may denote for a given period of time the number of vehicles of a certain type that are available from the service provider. At Step 1308, the Availability Engine 228 stores processed information in the Service Provider Specific Database 234 in association with each vehicle or service provider, depending on the processed content.

Business platform 200 may include availability information for a service provider that is seeking to create or have an affiliate handle a reservation. Availability engine 228 can determine availability for a particular reservation using a requesting service provider's own fleet and also the fleet of the service provider's affiliates. A service provider can use the output of the availability engine to book one or more reservations to itself or to its affiliates depending on the parameters for the reservation. The platform can store actual fleet information for a service provider. An actual fleet identifies a group of vehicles that are actually owned (or leased) by an operator. Availability engine 228 can use the actual fleet of a requesting service provider and may also use a virtual fleet to generate availability information. A virtual fleet includes a group of vehicles, or data representative of a group of vehicles, that are available through a requesting service provider's affiliate network (such as the sample network depicted in FIG. 12C). Both actual and virtual fleets can be available for reservation and dispatch for each service provider. In some embodiments, a virtual fleet includes capacity available from service providers that are not directly affiliated with a requesting service provider, but are indirectly affiliated through an affiliated service provider (as shown in the example of FIG. 12C). The platform can control this data and the availability of such data through the affiliation association. The platform can also implement requirements to control whether indirect affiliations are included in the virtual fleet (for instance, by using the validation element). The platform can block such association when the indirect affiliate does not meet certain business or operation requirements of a requesting service provider (e.g. the indirect affiliate is not party to an affiliate agreement governing certain services). The platform can also allow such inclusion in the virtual fleet when the requirements are met.

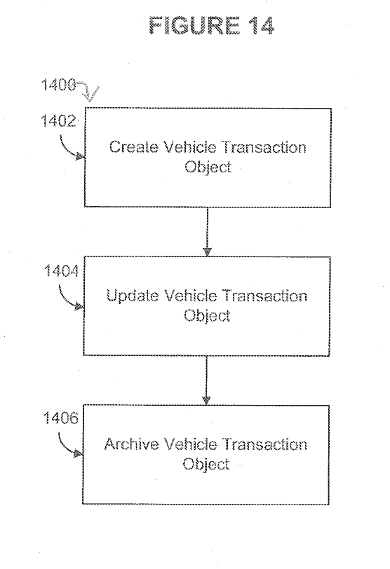

With reference to FIG. 14, a Reservation Element 222 may be implemented to facilitate the reservation of services between service providers. At Step 1402, the Reservation Element 222 may create a Reservation Transaction Object in the Reservation Transaction Object Database 236. The Reservation Transaction Object may be implemented to contain all the information associated with a reservation of services between service providers, such as through use of standardized format 420 shown in the example of FIG. 4B. As such, the Reservation Transaction Object may include information such as the original reservation criteria, the selection of an affiliate service provider to provide chauffeured ground transportation service on behalf of the requesting service provider, confirmation by the affiliate service provider that it will provide such service, a record of how the service was provided and billing information and resolution. At Step 1404, the Reservation Element 222 may provide updates to the Reservation Transaction Object as events occur in the business platform 200. For example, when services are rendered by the affiliate service provider, such as picking up a customer or completing a trip on behalf of the requesting service provider, the Reservation Element 222 may be notified with such information and update the associated Reservation Transaction Object. At Step 1406, the Reservation Element 222 may archive the Reservation Transaction Object, such as when all transactions associated with the reservation of services have been completed. Alternatively, the Reservation Element 222 may archive the Reservation. Transaction Object because a sufficient, amount of time has passed since the Reservation Transaction Object was last updated. Archiving the Reservation Transaction Object may be performed by the business platform 200 in various ways, including compressing the Reservation Transaction Object, transferring the Reservation Transaction Object to another storage facility, or deleting various aspects of the Reservation Transaction Object no longer considered of value.

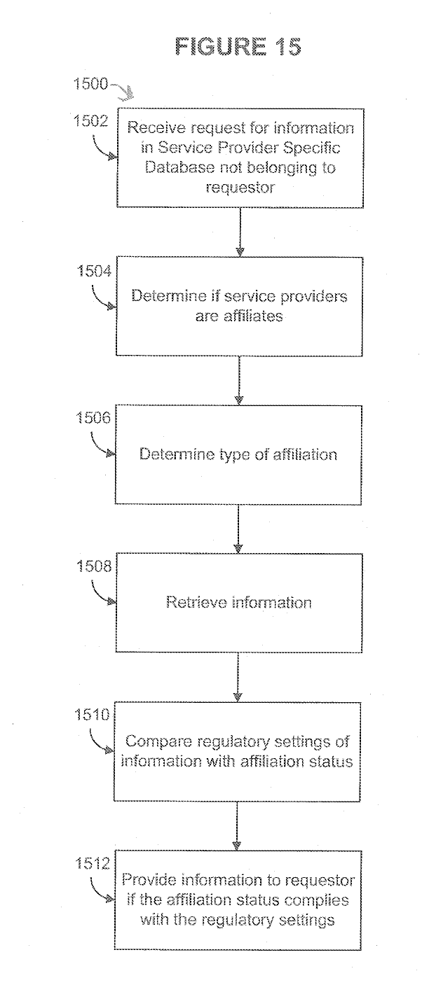

With reference to FIG. 15, a Regulatory Element 224 may be implemented to implement electronic constraints between service providers over the information that service providers have entered into the system. Regulatory Element 224 may act as a compliance element that records data and confirms, when using the recorded data, that the service providers are in compliance with ground transportation operation requirements from third party sources. In some embodiments, the Regulatory Element 224 is further configured to determine which service providers are not in compliance or will need to update their ground transportation requirements, and in response notifies service providers with sufficient information that one or more affiliate service providers are not compliance or will need to update their status. The Regulatory Element 224, in performing these functions, may also interact with Validation Interface Element 220 or Validation Element 226. In addition, when regulatory settings and affiliate relationships are provided to the platform, in some embodiments these may be entered through the Regulatory Element 224. As an example of how Regulatory Element 224 may utilize electronic constraints, a process 1500 may be implemented as shown in the example of FIG. 15. Beginning with step 1502. the Regulatory Element 224 may receive a request by the platform to the Service Provider Specific Database for information associated with another service provider. At Step 1504, the Regulatory Element 224 may first determine if the service providers involved in the request are affiliates. At Step 1506, if the service providers are affiliates, the Regulatory Element 224 may retrieve the type of affiliation between the service providers (e.g., first level, second level, etc.). At Step 1508, the Regulatory Element 224 may retrieve the information requested from the Service Provider Specific Database. At Step 1510, the Regulatory Element 224 may use the regulatory settings associated with the information to determine if it permits disclosure based on the type of affiliation between the service providers. Such regulatory settings may include those entered by service providers as well as regulatory settings entered or created by other sources, such as the platform itself At Step 1512, the Regulatory Element 224 may provide the information requested upon determining that the information should be released. Otherwise, the Regulatory Element 224 will not allow the information to be sent.

Regulatory element 224 can be implemented to regulate electronic relationships between service providers. The platform can permit services providers to selectively establish relationships with other service providers on the network. The Regulatory Element 224 can control the service provider specific data that is stored by the platform. A first portion of service provider specific data can be information that is available without restrictions to members of the platform. For example, this can be basic company information such as company name, location, or for example other information that is generally available publicly. A second portion of service provider specific data can include information that is made available to a service provider's affiliated service providers, information that can be generated or deduced from service provider specific data and made available to a service providers' affiliated service providers, or combinations thereof. Other forms of first portion or second portion data can be included. It is also possible for some overlap in the data between the two portions. In operation, Regulatory Element 224 can imply fewer or different restrictions to first portion than the second portion. For example, Regulatory Element 224 can limit or block which elements can use which data portions. Regulatory Element 224 can also block the second portion to be used by one or more elements such as a reservation element when two service providers are not affiliated. Regulatory Element 224 can use the two data portions to regulate the activity within the platform and implement electronic relationships between services providers on the platform.
If desired, Regulatory Element 224 can perform authentication and store necessary information to allow access using authentication. Regulatory Element 224 can maintain different electronic criteria between different service providers on the platform to, for example, establish different financial rates that affiliated services providers may have agreed with each other.

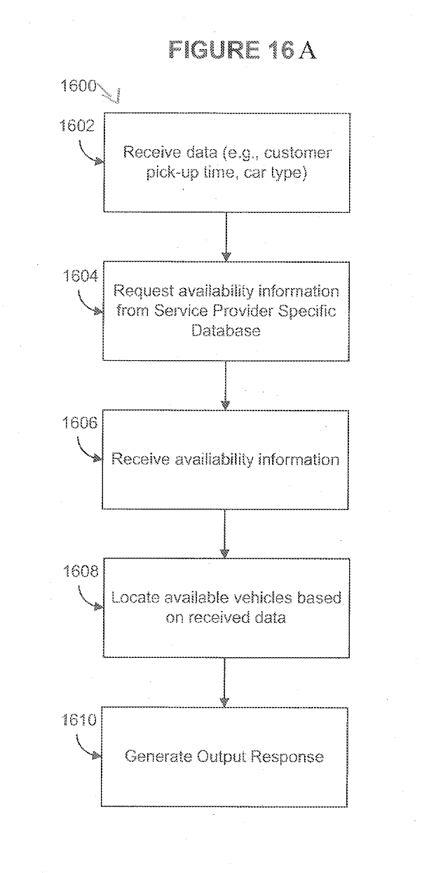

With reference to FIG. 16A, a Search Element 232 may be implemented to assist a service provider in locating an affiliate service provider to handle a reservation of livery service on its behalf. Search process 1600 begins with Step 1602, in which the search element may receive data regarding the service needed (e.g., customer pick-up time, vehicle type, geographic location). At Step 1604, the Search Element 232 will request availability information created by the Availability Engine 228 from the Service Provider Specific Database. In some embodiments, the request for the availability information may pass through the Regulatory Element 224. At Step 1606, the Search Element 232 receives the availability information. At Step 1608, the Search Element 232 processes the availability information to locate affiliated service providers with vehicles available matching any criteria established by the data regarding the service needed. At Step 1610, the Search Element 232 generates an output response based on the processing of the availability information, which may then be sent to other parts of business platform 200. A sample output response is shown in FIG. 16B as an availability matrix generated by the Search Element 232. The availability matrix can show costs for hiring various types of vehicles from affiliate service providers and service providers within a virtual fleet. The availability matrix may specify minimum or maximum rates based on geographic location, vehicle type, date and time of service and other relevant variables chosen between the service provider and the affiliate service provider.

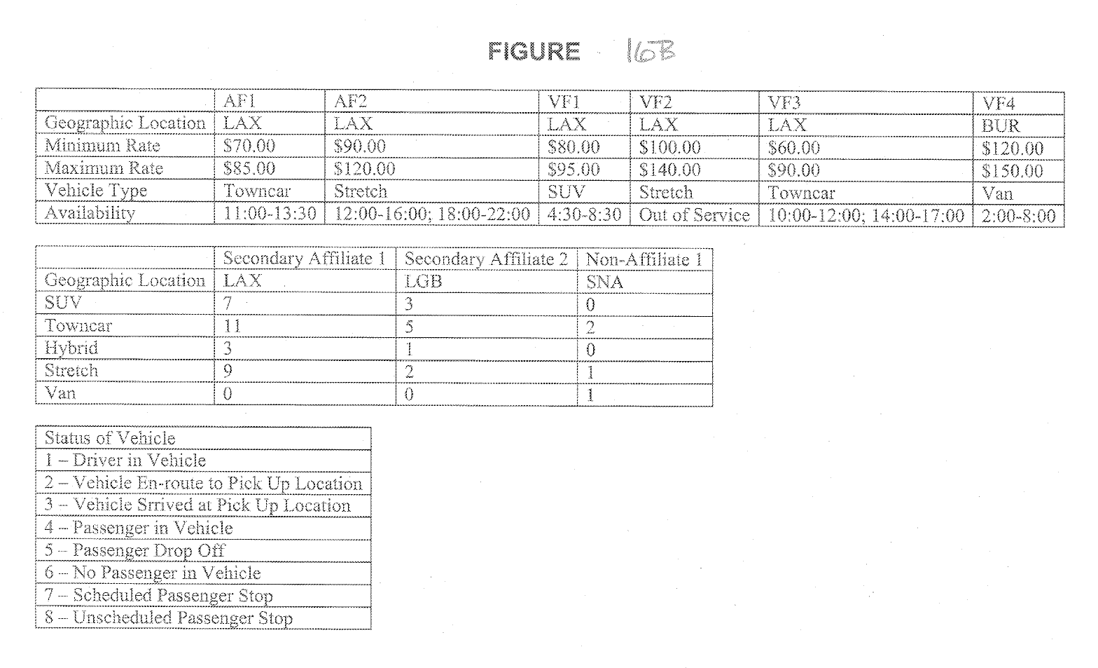

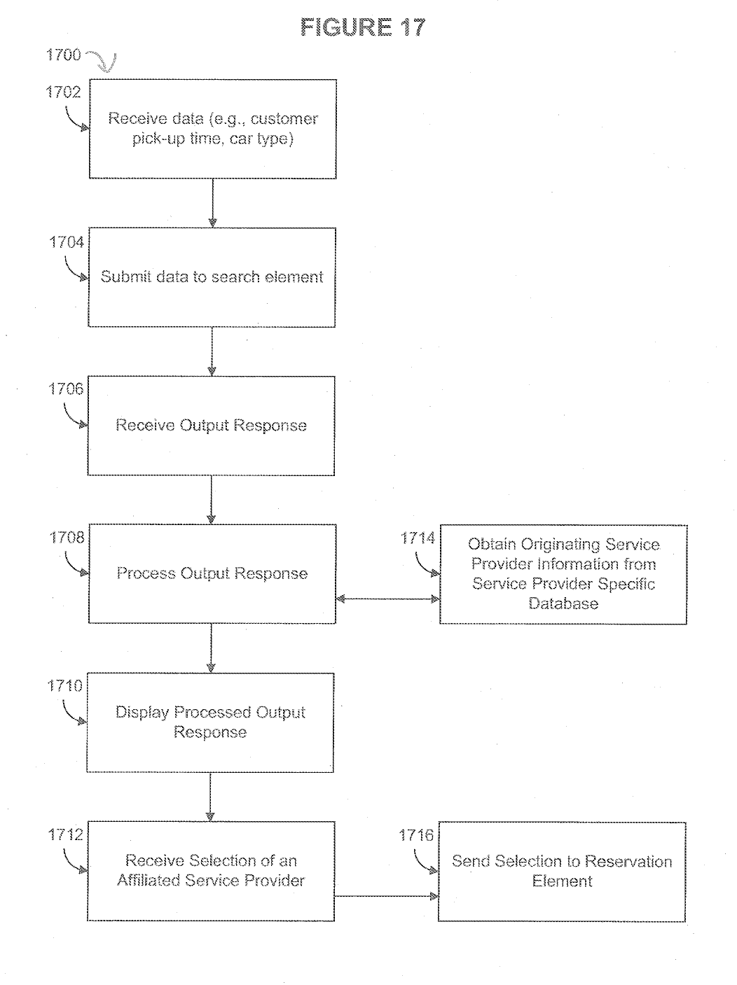

With reference to FIG. 17, a Reservation Interface Element 214 may be implemented to assist service providers in obtaining service on their behalf from their affiliated service providers. The Reservation Interface Element 214 may be implemented to initiate a process 1700 which begins with Step 1702. In Step 1702, the Reservation Interface Element 214 may receive data regarding the service needed (e.g., customer pick-up time, vehicle type, geographic location) from the service provider. At Step 1704, the Reservation Interface Element 214 will submit the received data to the Search Element 232. At Step 1706, the output response generated by the Search Element 232 is received for processing. At Step 1708, the Reservation Interface Element 214 processes the output response for display to the service provider. As part of this process, the Reservation Interface Element 214 may request information about affiliate service providers from the Service Provider Specific Database 234 (e.g., ratings, display preferences) as shown in Step 1714. In some embodiments, the Reservation Interface Element 214 may also ensure that information about the affiliated services providers are accurate using the Validation Interface Element 220 or the Validation Element 226 and notifying the services provider if there are any inconsistencies or non-compliance issues. At Step 1710, the Reservation Interface Element 214 may display the processed output response to the service provider. At Step 1712, the Reservation Interface Element 214 may receive a selection of an affiliated service provider for the purpose of specifying that the affiliated service provider should handle the reservation on behalf of the originating service provider. If the Reservation Interface Element 214 does not receive a selection, the process may terminate. At Step 1716, the Reservation Interface Element 214 may then send the selection to the Reservation Element 222 to update a Reservation Transaction Object associated with the reservation. As Part of Step 1716, the Reservation Interface Element 214 may also request that the Reservation Element 222 also create the Reservation Transaction Object associated with the reservation. In some embodiments, the Reservation Interface Element 214, when it receives the data in Step 1702, may request that the Reservation Element 222 create the Reservation Transaction Object associated with the reservation.

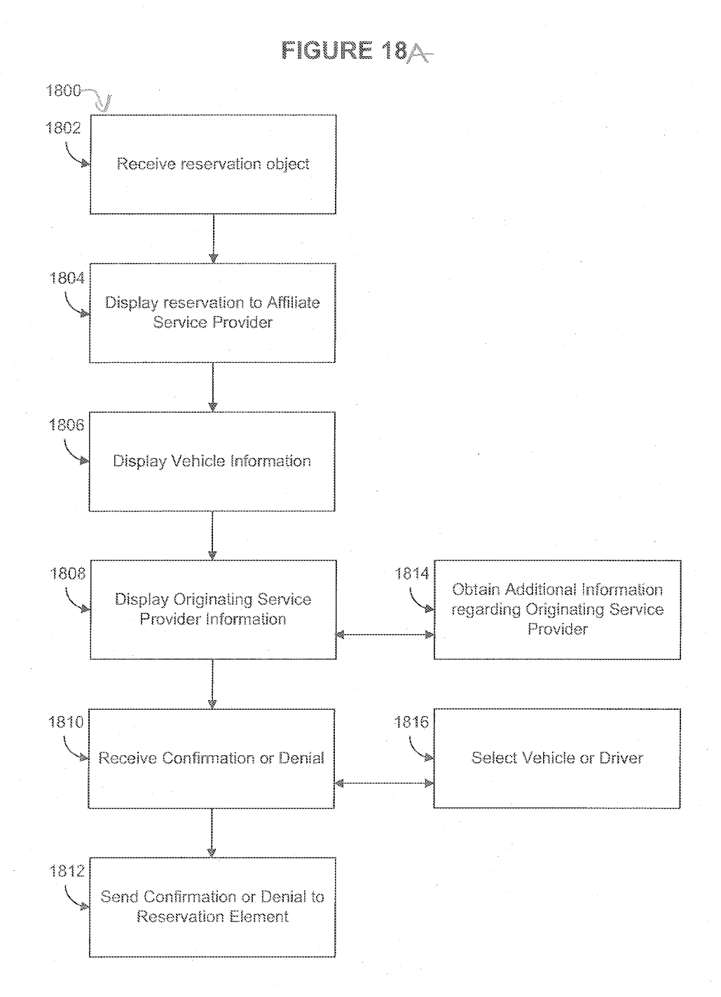

With reference to FIG. 18A, a Dispatch Interface Element 218 may be implemented to assist service providers in determining if they wish to provide service on the behalf of other service providers. The Dispatch Interface Element 218 (shown in FIG. 2) may be implemented to initiate a process 1800, which begins with Step 1802. In Step 1802, the Dispatch Interface Element 218 may receive a Reservation Transaction Object indicating that an originating service provider has selected the service provider to handle service on its behalf. At Step 1804, the Dispatch Interface Element 218 may display the reservation to the service provider. At Step 1806, the Dispatch Interface Element 218 may also provide information about vehicles that are available from the service provider to fulfill the reservation. The available vehicles may be vehicles owned and operated by the service provider. In some embodiments, the available vehicles may also include vehicles owned and operated by affiliate service providers that are included in a virtual fleet. An example of a virtual fleet's available vehicle inventory is depicted in FIG. 18B. FIG. 18B shows a virtual fleet diagram showing the fleet of vehicles available among operators A, B, C, D and E. Solid lines between operators (as shown between operators A and B, B and C, B and D, and D and E) represent affiliated or “first level” relationships between those operators. Dotted lines between operators (as shown between operators A and C, and A and D) represent “second level relationships between those operators. FIG. 18B shows a list of each operator's actual vehicle inventory and virtual vehicle inventory, including the vehicle identification numbers (“VINs”) for each vehicle. Depending upon the level of the relationship between operators, the Dispatch Interface Element 218 may provide any operator vehicle fleet information about any other operator. For example, operator A may not be able to see operator C's actual fleet unless operator C chooses to make its actual fleet visible to second level relationships. It is understood that the virtual fleet diagram of FIG. 18B is merely an example of the inventory configurations that are available within a network.

At Step 1808, the Dispatch Interface Element 218 may also display information regarding the service provider originating the reservation. As part of Step 1808, the Dispatch Interface Element 218 may also make additional requests for information about the service provider originating the reservation through the Regulatory Element 224 as shown in Step 1814. At Step 1810, the Dispatch Interface Element 218 may receive a confirmation or denial from the service provider that they will handle the reservation. If the Dispatch Interface Element 218 receives a confirmation that the service provider will handle the reservation, it may then prompt the service provider to select a specific vehicle or driver to handle the reservation as shown in Step 1816. At Step 1812, the Dispatch Interface Element 218 sends the confirmation, including any selection of vehicles or drivers, or the denial to the Reservation Element 222 to update the Reservation Transaction Object associated with the reservation.

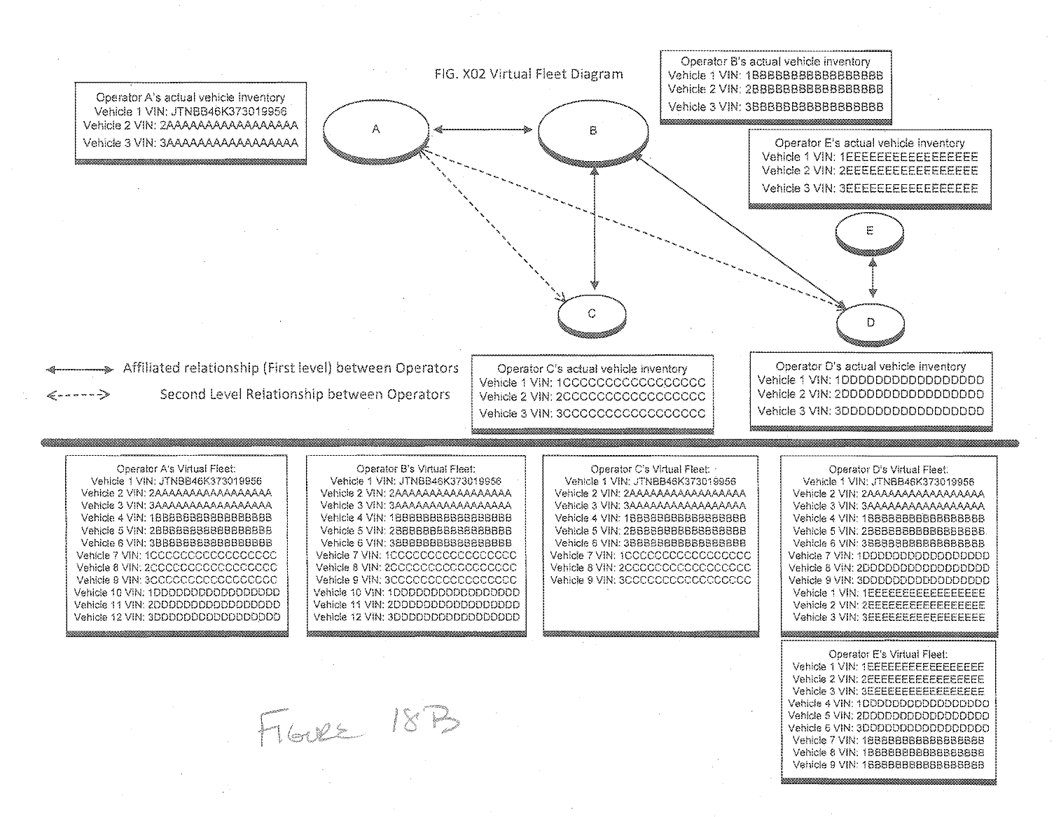

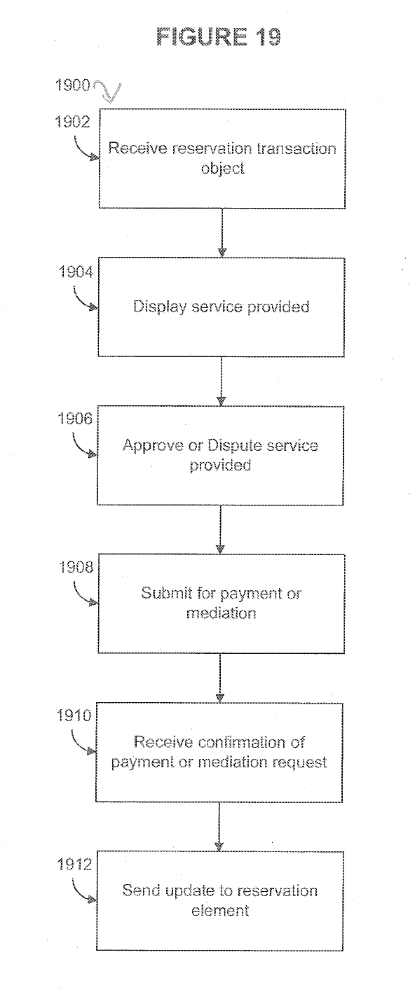

With reference to FIG. 19, a Management Interface Element 212 may be implemented to assist service providers in also reconciling payment for services rendered on their behalf by other service providers. The Management Interface Element 212 may be implemented to initiate a process 1900, which begins with Step 1902. In Step 1902, the Management Interface Element 212 may receive a Reservation Transaction Object indicating a request for payment for service rendered by an affiliated service provider. At Step 1904, the Management Interface Element 212 may display the service that was rendered by the affiliated service provider. At Step 1906, the service provider may confirm or dispute the services listed by the affiliated service provider. In some embodiments, Step 1906 may also include receiving a partial confirmation and partial dispute of the services rendered by the affiliated service provider (e.g. confirmation for scheduled services rendered, but a dispute for unscheduled services). At Step 1908, the Management Interface Element 212 may submit the confirmation or denial to the platform 200. This may result in the platform issuing payment to the affiliated service provider or initiating a mediation process to resolve any disputes over the services rendered. At Step 1910, the Management Interface Element 212 may receive confirmation that payment was received or that a mediation process was initiated from the platform. At Step 1912, the Management Interface Element 212 may then send an update to the Reservation Element 222 to update the Reservation Transaction Object associated to show that payment was made or that services were disputed. With reference to FIG. 20A, the above processes may provide a service provider with the following functionality when it may require that another service provider handle a reservation. A process 2000 begins with Step 2002, in which the service provider may register with the platform using the Management Interface Element 212, such as providing information about the service provider's company, its vehicles, its employees, etc. If the service provider is already established as a “member” of the community that can access business platform 200, the service provider will have already provided such information and can access the platform directly, for example through a login screen as previously described with respect to FIG. 3B. If the service provider is a member of an affiliate network but not a member of the platform community, the sign-in screen of FIG. 3B may permit the service provider to become a member via a self sign-on application as shown in FIG. 20B. If the service provider is neither a member of an affiliate network nor a member of the platform community, an affiliate service provider may issue the service provider an invitation to become affiliated (or otherwise provide service at any other level). An example of a non-member affiliate invitation is shown in FIG. 20C.

Once a non-member service provider becomes a member service provider, the member service provider can set up its platform profile and access the platform as shown in FIGS. 20D, 20E, 20F and 20G. As shown in the example of FIG. 20D, a member service provider can access a “home” page at which the service provider can edit the service member's profile, access a physical or virtual fleet of the service provider and/or the service providers network of affiliates, review industry and member notices (for instance, as provided by one or more feeds shown in feed ribbon 2000), manage affiliate relationships, manage reservations and perform other functions as described above. For example, a service provider who wants to manage its profile can manage its own corporate information as shown in the example of FIG. 20E. FIG. 20E displays the information that the service provider provided upon becoming a member of the platform community, which information may include, but is not limited to, information regarding whether the service provider is a corporate (“fleet”) or an independent operator; where the service provider's physical address is; the details and status of the operator's business license; and other corporate details including but not limited to state of incorporation, tax ID number, insurance information, the status of the corporation as a recognized provider of services to government and/or non-profit organizations, etc. Insurance information in the member's profile may include carrier information and thresholds carried by the service provider for each vehicle. Such information may also include information regarding workers' compensation coverage and general liability coverage, which may be particularly when threshold coverage is required by law, regulation and/or contract. The service provider information can also include information regarding each driver's right to drive, including information regarding each driver's driving record, the state in which each driver's license is issued and whether each driver is in compliance with any regulatory and/or contractual requirements governing driving records (for example, whether a driver has received additional security training, or whether a driver has a commercial driving license or a restricted license). As shown in the example of FIG. 20F, the service provider can establish notification settings for sending and/or receiving affiliate requests, reservation requests and any other information (for instance, as by phone, SMS, email and by any other similar and complementary notification means). An affiliate request as shown in FIG. 20F may include a link to affiliate data as shown in the example of FIG. 20G, thereby providing a service provider with suitable information to make an informed decision about whether to accept or deny an affiliate request. In the example of FIG. 20H, the service provider, depending upon the level of its relationship with a particular service provider that is requesting affiliation and/or requesting that service be provided, can access an appropriate affiliate price sheet and/or contract for immediate review, thereby enabling the service provider to execute a performance and price comparison among affiliates at the various relationship levels. A service provider may also use this information when reviewing affiliate data as shown in FIG. 20G to find synergies between the service provider making the affiliate request and the existing members of a service provider's affiliated network. It is understood that the information provided is not limited to that shown and described with respect to FIGS. 20D to 20H and that other information may be provided in other forms and by other means.

Referring back to FIG. 20A, at Step 2004, the Management Interface Element 212 may also assist the service provider with establishing its affiliate relationships to other service providers (for instance, by issuing affiliate requests to service providers as shown in the example of FIG. 20F). At Step 2006, the service provider may use the Reservation Interface Element 2 I 4 to locate an affiliate service provider with a vehicle that can provide service on its behalf. At Step 2008, the service provider may select an affiliate service provider to handle the service on its behalf or it may terminate the search. At Step 2010, if the affiliate service provider accepted the reservation and performed the service, the service provider may receive a request to pay for the service through the Management Interface Element 212. At Step 2012, the service provider may then use the Management Interface Element 212 to provide payment to the affiliate service provider for the services rendered.

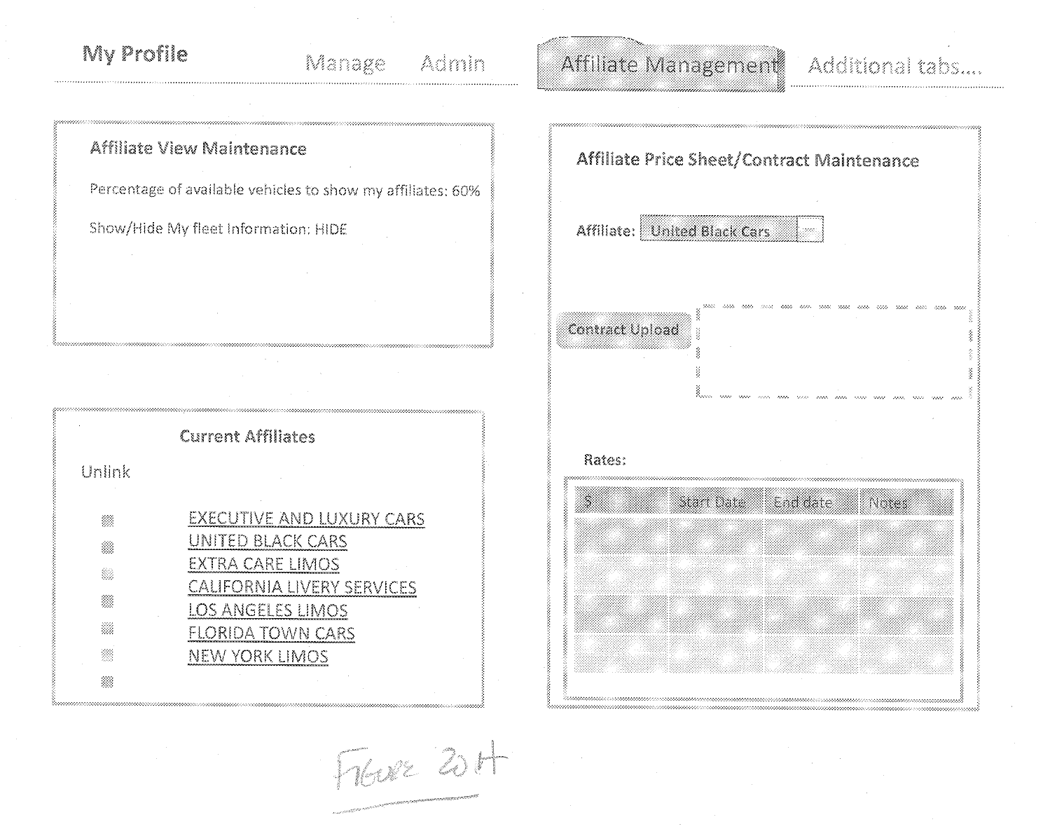

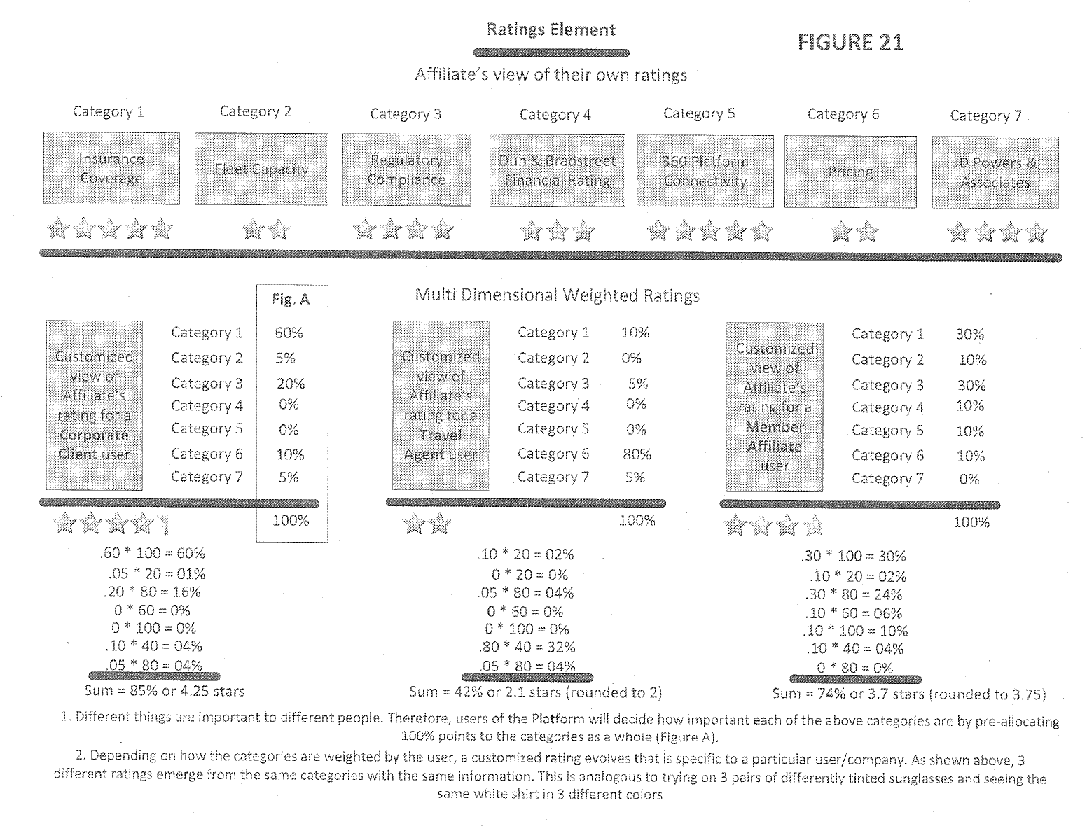

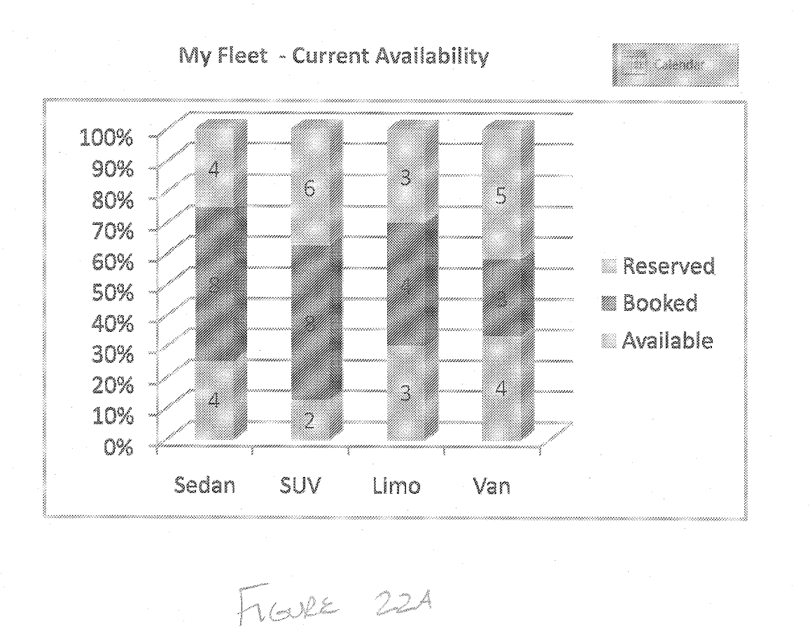

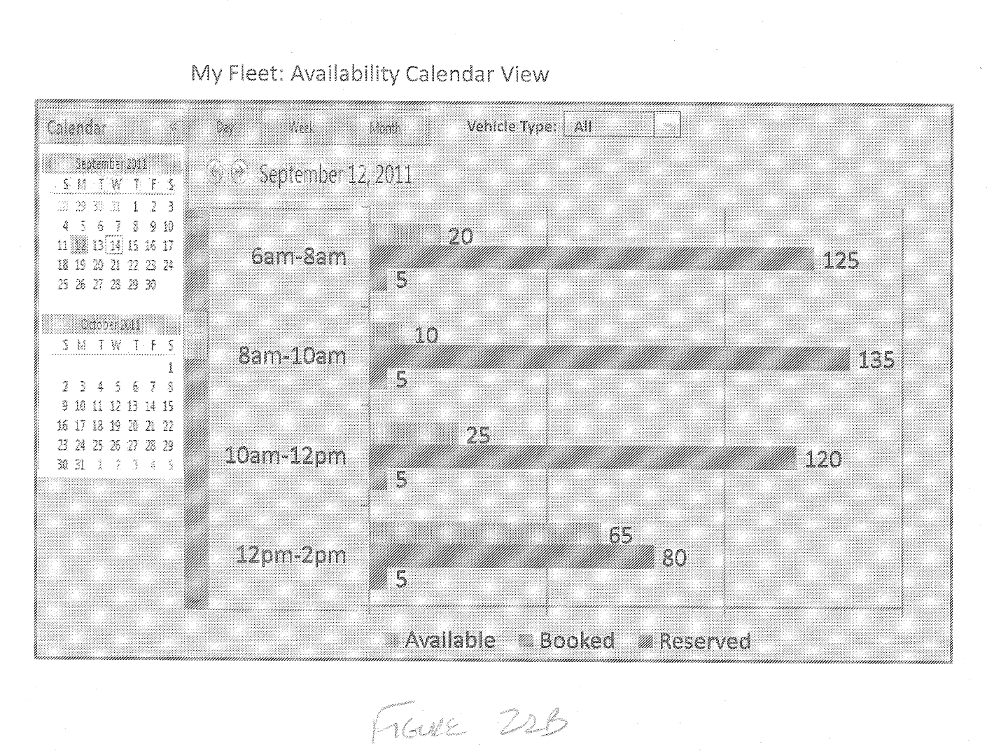

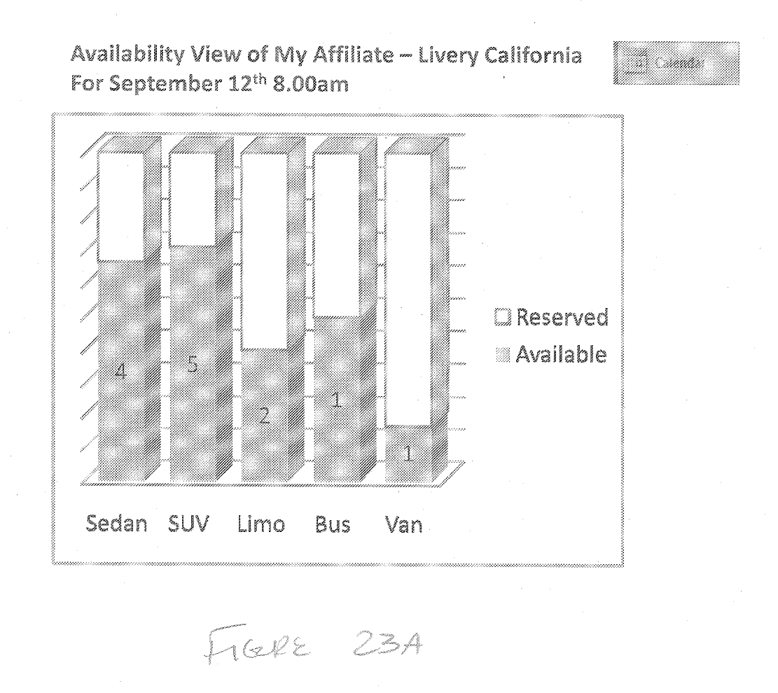

FIG. 21 describes and provides an illustrative interface for a new rating or analysis feature. A feature can be provided in which a user such as a service provider can be given the interactive option to specify the weighted important of different categories. Each category may reflect a particular quality or characteristic of a service provider. In the example of FIG. 21, each service provider is permitted to specify a set of weights that together add up to 100%. This permits the user to determine how to apportion its budget of percentages to appropriately correspond to its situation. Each category may be assigned a rating (e.g., one to five stars) for use in searching and evaluating service providers. The weights as specified can be applied to the rating stored for each category and for each service provider to generate a resulting rating. That resulting rating is “personal” to the service provider that is viewing the rating of any service provider. In other words, the rating of operator B as viewed by operator A may be different than the rating of operator B as viewed by operator C because operators A and B each defined a set of weights differently in correspondence to the respective importance of each category. This provides a valuable tool for the service provider to evaluate and ultimately select other service providers to handle a reservation. A financial element such as Financial Element 205 (shown in FIG. 2) can also be implemented. The financial element can be implemented to work cooperatively with other elements to provide a complete business to business solution. For example, the financial element can be. implemented to invoices or to make payments between affiliates to pay for business transactions such as completed transportation events. A financial element can generate a trip ticket detailing all fees, taxes, or other costs for a customer that received the transportation service and/or can generate a trip ticket for a requesting service provider. Tickets or invoices can be generated when a status received that the services has been provided, e.g., customer drop off. A financial element can be implemented to handle payment account and use payment processing to handle payments. A standardized data object can be implemented such for implementing on a business-to-business chauffeured ground transportation platform. An object can be configured to be keyed to an individual reservation. The standardized object can be an item that can be communicated to service providers. The object can carry or contain the data generated as a result of a particular reservation or transaction on the platform. The object can be configured to include reservation, financial, and comments information generated from each reservation. This can permit an entire record from a transaction to be contained in a structured data relationship. In addition, an object can be configured to handle a transaction between two service providers irrespective of each party's system implementations. If desired, an object can store different legs of a reservation and be transferred between different systems or service providers that carry that information for future use. The standardized data object can be defined to have a structure having three categories: reservation, dispatch, and billing (although other structures are contemplated that are not limited to these three categories). The object can be configured to be saved in a database. The data fields for the object establish a structured relationship for the data corresponding to the life of a reservation (e.g., reservation, dispatch, and billing). A SQL database can be used for implementing the database. The standardized data object can also be configured to have the structure to store comments or ratings by the customer or service providers. The object can be part of a financial and business component in which the platform can generate invoices (e.g., automatically when a ride is completed). The platform can provide access to the service providers involved through interactive tools to add information such as comments in connection with an individual ride that has been invoiced and stored in a standardized object. By using the data in the standard object, a service provider can also review the details of the reservation such as its timeliness, charges, driver, or other information made available by the object. As such, the object and platform can provide a consolidated resource for billing, viewing underlying reservation details, evaluating an affiliate's performance, electronically negotiating issues with a bill, or paying invoices. As such, a database can be implemented on a system and the system can be configured to collect data generated from, or as a result of, a reservation message and store that data (e.g., the data directly generated from a reservation) in a relational database in which the data object is structured to provide access to the data such that businesses can receive invoices and view and evaluate related information. The data in the standard object can indicate compliance with regulatory and contractual standards and can also recognize contractual obligations between certain affiliates. This feature simplifies contract management and auditing and consequently simplifies reconciliation for tax and other corporate recording and reporting purposes. Live search element 214 can operate to provide an interactive feature in which a service operator can view the status and location associated with a service provider's own vehicle(s), with vehicles that are in the service provider's affiliate network, and combinations thereof. Live search element 214 can be configured to have access to status information, location information, vehicle identifying information, and other information that it uses to provide a current state in geographic and operational sense (e.g., carrying passenger, available) to a service provider such as through an interactive table or through a map view. The example of FIG. 22A shows a depiction of a service provider's entire stable of vehicles according to vehicle type (e.g., sedan, SUV, limo and van may comprise common vehicle types, although other vehicle types may be contemplated, such as exotic or commercial), along with an indication of how many vehicles of a certain type are reserved, booked or available. As shown in the example of FIG. 22B, a calendar applet may be included that shows this information in a calendar format. The examples of FIGS. 23A and 23B show corresponding information for one or more affiliates so that a service provider can have a complete picture of availability within an entire virtual fleet. Access to the information shown in FIGS. 23A and 23B may be dependent on the level of relationship between service providers. For example, with reference to FIG. 18B, operator A might be able to see that operator C has 3 SUVs and 2 sedans as inventory yet operator A will not be able to view the actual availability of operator C's vehicles because operators A and C are not directly affiliated (thereby encouraging the first level relationship between operators A and B such that operator B can use its affiliation with operator C to provide service to A).

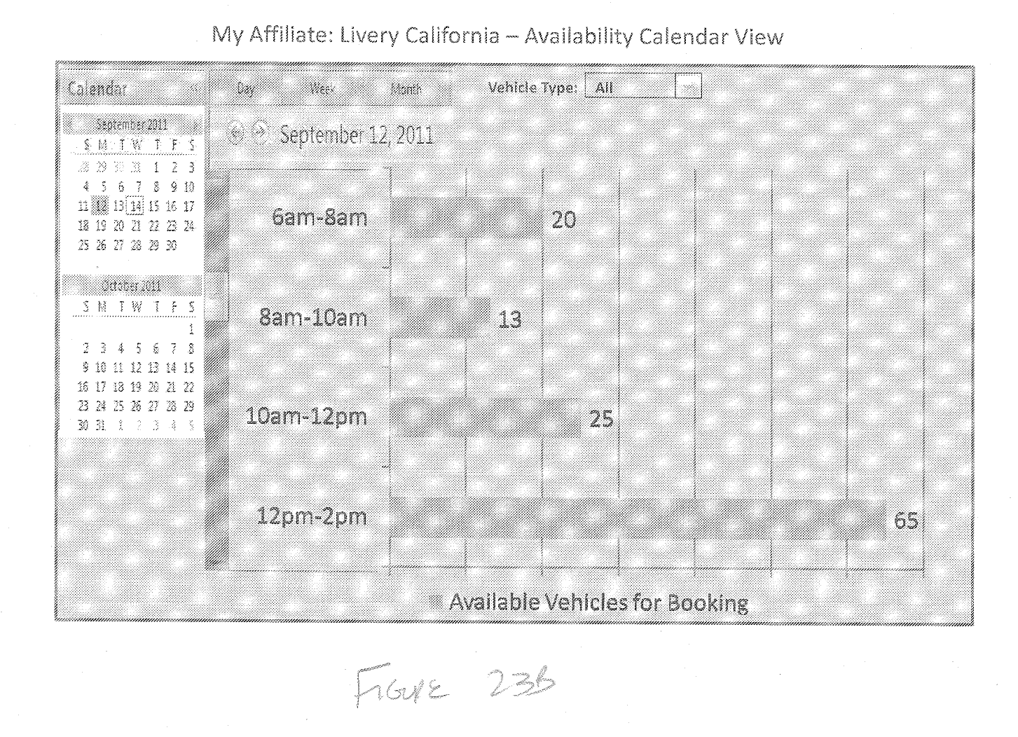

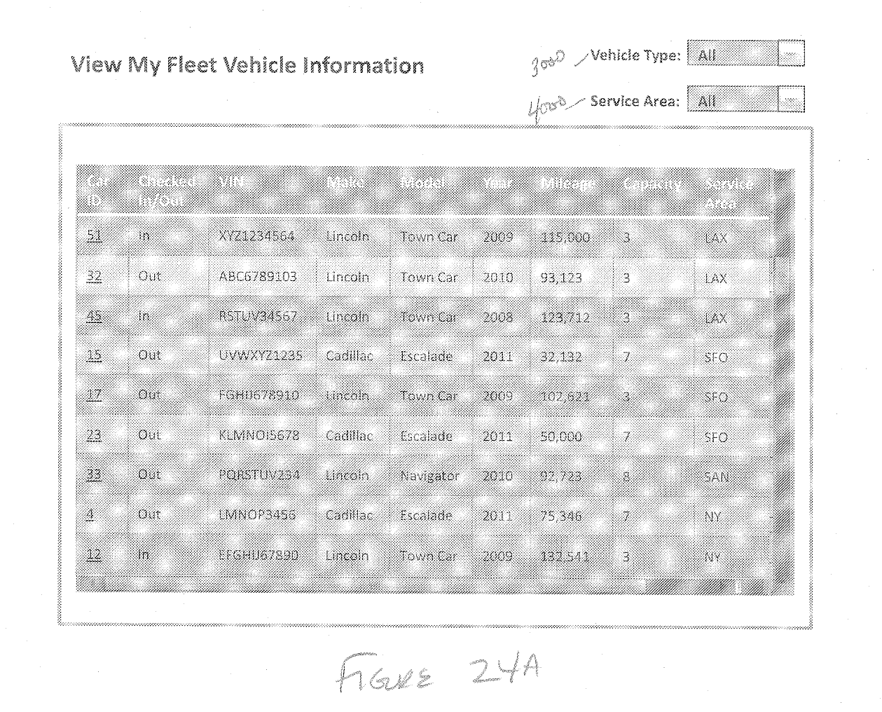

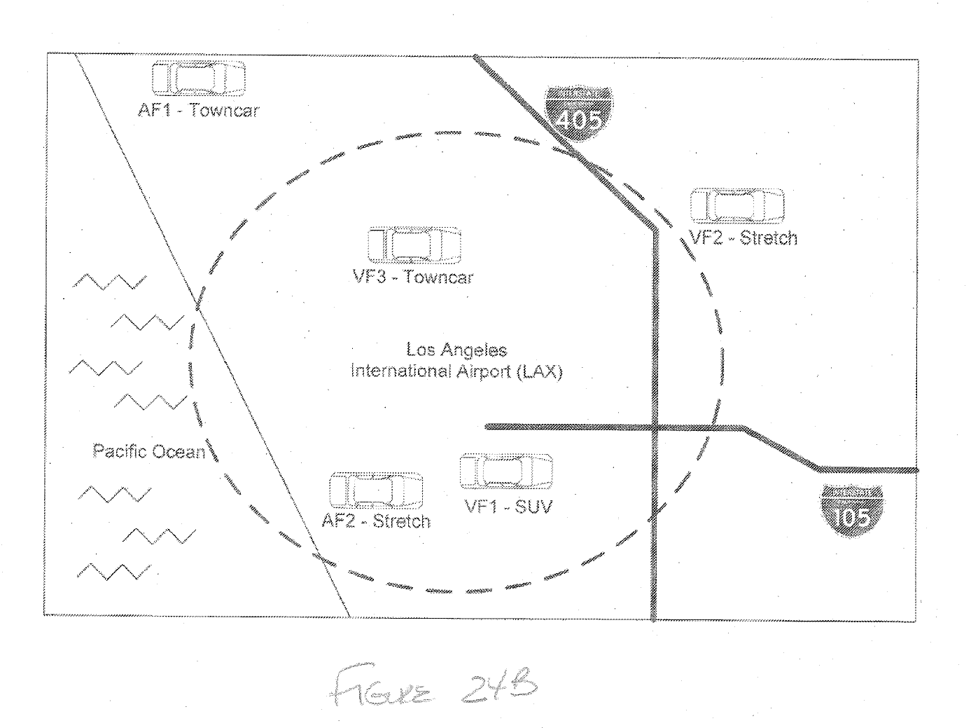

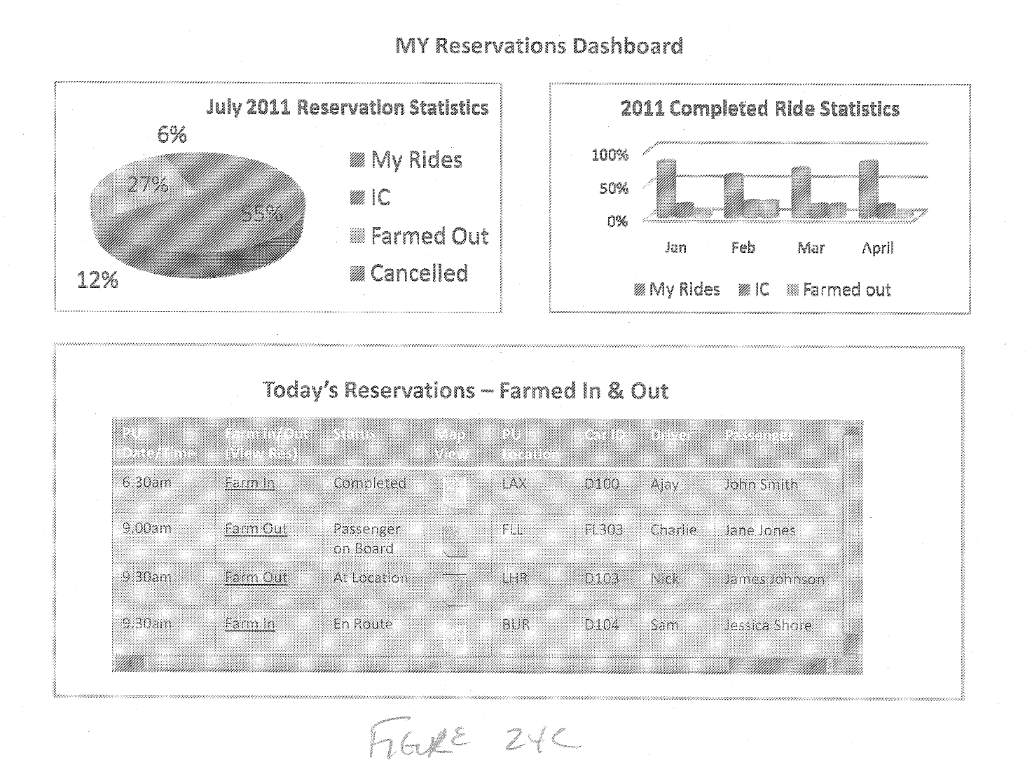

The example of FIG. 24A depicts a page showing information in a table format. The depicted information can include a vehicle's ID number (which can be either or both of the VIN number and/or the service provider's own assigned number for the vehicle), availability, make and model, passenger capacity and service area. The availability of such information ensures that the selected service provider has the requested vehicle, experience and regulatory capacity to perform services on behalf of the requesting service provider. A service provider can refine search results according to any desired criteria, including but not limited to vehicle type (which can be indicated at a pull-down menu 3000 shown in FIG. 24A), service area (which can be indicated at a pull-down menu 4000 shown in FIG. 24A) and “extra services” provided by a service provider (e.g., wheelchair-friendly transportation, availability of multilingual drivers, etc.). The table may have a link to a map view as shown in the example of FIG. 24B, which map view shows the relative proximity of vehicles respective to a desired focal point (for example, Los Angeles International Airport). For example, the use of software-enabled smart phones, tablets or other devices by drivers or service operators can provide real time, current, or approximately current data to the platform. The table may also have a link to a reservations dashboard as shown in the example of FIG. 24C, in which a service provider can evaluate performance data as well as data regarding jobs that have insourced (“farmed in”) or outsourced (“farmed out”) relative to other service providers in the platform community. The pages shown herein are examples of the type of information to which Live Search Element 214 can have access and examples of the presentation of such information to members of the platform community.

The platform can also allow reservations to be accepted quickly by the driver or service operator. A service provider can view the current state of its actual fleet or virtual fleet and select an affiliate and/or a specific a vehicle (e.g., based on proximity, state of reservation (e.g., near complete), or other factors). The platform in response can send a reservation to a corresponding service provider, which may be communicated to an operator in a vehicle (e.g., the one selected). Acceptance of the reservation by the service operator or driver in a vehicle confirms that the reservation is accepted and if desired, implements any necessary dispatch operations and related data activity. As such a system, process, or non-transitory computer readable medium is provided that can display status information and permits users to view a corresponding geographic location through an interface or interface communications, the system, process, or non-transitory computer readable medium can receive a selection to view a geographic location from a an interactive table (view), which can be generated in response to search for reservation capability (of actual and/or virtual fleet). In response to a selection of a particular affiliate or vehicle from the display, a message identifying a potential reservation is sent to a service provider and/or directly or indirectly to a vehicle (e.g., if a service provider is an independent provider having one car and a mobile device for interacting with the platform), a message accepting, rejecting, or taking some other action can be received back in response to the reservation message, which can be received the platform, and as it would be understood, components or elements therein. Acceptance can serve as a potential dispatch if necessary.

It is understood that activity described from a user's perspective also encompasses the related features that are implemented on the system, platform, software, or process as part of providing that activity or interaction. Illustrative examples have discussed implementing a browser based interface for using or interacting with the platform. Application specific software such as applets or other software can also be used such for example through standard communications such as using Internet standard or standardized travel communications protocols. Data entry can be implemented by service provider or by other means such as automated data collection, or entry by a platform operation or third party, or other means. A platform can generally refer to software, hardware, or combinations thereof. A platform, element, or virtual machines can include data depending on the context and situation. The term “data” is sometimes used herein to include one or more of the following: information, database entries, data for supporting software applications, multimedia files, other types of files, graphics, images, software, selectable resource options, and software modules. The systems and methods described herein are not limited to a hardware or software configuration; they can find applicability in many computing or processing environments. The systems and methods can be implemented in hardware or software, or in a combination of hardware and software.

In one embodiment, a network cloud is described to be implemented as part of the process or system. If desired, other technical configurations can be implemented such as, distributed servers of different operators providing the describe functionality, one or more servers locally over a network, or one or more virtual servers in a single device. The systems and methods can be implemented in one or more computer programs, in which a computer program can be understood to include one or more processor-executable instructions. The computer programs can execute on one or more programmable processors, and can be stored on one or more storage media readable by the processor, comprising volatile and non-volatile memory and/or storage elements. The computer programs can be implemented in high level procedural or object oriented programming language to communicate with a computer system. The computer programs can also be implemented in assembly or machine language. The language can be compiled or interpreted. The computer programs can be stored on a storage medium or a device (e.g., compact disk (CD), digital video disk (DVD), magnetic tape or disk, internal hard drive, external hard drive, random access memory (RAM), redundant array of independent disks (RAID), or removable memory device) that is readable by a general or special purpose programmable computer for configuring and operating the computer when the storage medium or device is read by the computer to perform the methods described herein. Unless otherwise provided, references herein to memory can include one or more processor-readable and -accessible memory elements and/or components that can be internal to a processor-controlled device, external to a processor-controlled device, and/or can be accessed via a wired or wireless network using one or more communications protocols, and, unless otherwise provided, can be arranged to include one or more external and/or one or more internal memory devices, where such memory can be contiguous and/or partitioned based on the application. Unless otherwise provided, references herein to a processor or microprocessor can be understood to include one or more processors that can communicate in stand-alone or distributed environment(s) and can be configured to communicate via wired and/or wireless communications with one or more other processors, where such one or more processor can be configured to operate on one or more processor-controlled devices that can include similar or different devices. Use of such processor and microprocessor terminology can be understood to include a central processing unit, an arithmetic logic unit, an application specific integrated circuit, and/or a task engine, with such examples provided for illustration and not limitation. Unless otherwise provided, use of the articles “a” or “an” herein to modify a noun can be understood to include one or more than one of the modified noun.

While the systems and methods described herein have been shown and described with reference to the illustrated embodiments, those of ordinary skill in the art will recognize or be able to ascertain many equivalents to the embodiments described herein by using no more than routine experimentation. Such equivalents are encompassed by the scope of the present disclosure and the appended claims. For example, the disclosed systems and methods are not limited to implementation in a client-server infrastructure, but can be implemented in one or more infrastructures known to those of ordinary skill in the art, such as, but not limited to, peer-to-peer infrastructures.

With respect to the processes described, it should be understood that the components of the process can be implemented in a different order than specified, that the process can be implemented without a process set or component, or that different processes can be combined. The terms “adapted”, “configured”, or “adapted and configured” indicate that software, hardware (including computer readable), or combinations thereof are implemented by way of computer programs or circuitry to implement a particular structure. If the terms are not specifically used, one of ordinary skill in the art will understand that it was contemplated in general or based on the specific context.

It should be understood that the above description of the invention and specific examples, while indicating preferred embodiments of the present invention, are given by way of illustration and not limitation. Many changes and modifications within the scope of the present invention may be made without departing from the spirit thereof, and the present invention includes all such changes and modifications. Although embodiments described above are directed to chauffeured ground transportation for hire or livery car services, it is contemplated and understood that they are applicable and useful in other applications, such as other forms of transportation such as chartered bus, private jets, or other forms of transportation involving other types of vehicles, class of transport (e.g., freight transport using trucks), or combination thereof. In addition, features and components of the platform may be applicable to other services, systems, or other industries.

While particular embodiments of the disclosed method and system have been illustrated and described, it is obvious to those skilled in the art that various changes can be made without departing from the spirit and scope of the disclosure. It is therefore intended to cover all such changes that are within the scope of this disclosure in the appended claims.

What is claimed is:

1. A computer-implemented business platform for business-to-business operations between chauffeured ground transportation service providers over a network that is configured and adapted to support multiple service providers over a network communications connection, comprising:
a network interface for communicating over the network and accessing the platform by registered service providers that provide service provider specific data during registration;
a reservation element implemented on the network that creates reservation transaction objects that include all information associated with a reservation;
a reservation transaction object database that stores reservation objects detailing individual reservation transactions,
an availability engine that collects and analyzes service provider information and determines availability of at least one service provider to fulfill one or more individual reservation transactions;
a regulatory element using at least portions of the service provider specific data to regulate activity within the platform, wherein the regulatory element implements a set of electronic constraints that create and control affiliate relationships between service providers on the platform and control accessibility of the portions of the service provider specific data;
a search element implemented to assist a service provider in locating an affiliate service provider to handle a reservation of chauffeured ground transportation service on its behalf, the search element receiving data requirements specifying one or more individual reservation transactions to be fulfilled, wherein the search element is configured and adapted to receive the data requirements and generate an output response based on the data requirements, the service provider specific data, and the electronic constraints; and
a reservation interface element that is configured and adapted to permit a requesting service provider to select one of its affiliated service providers for the reservation, wherein the interface permits the requesting service provider to select an affiliated service provider from the output response to specify that the affiliated service provider should handle the reservation and generates an update to a data field that records the selection by the requesting service provider of the particular affiliated service provider to handle the reservation.

2. The platform of claim 1 wherein the service provider specific data includes fleet data specifying details of a service provider's chauffeured motor ground transportation vehicles, the fleet data being stored on the platform.

3. The platform of claim 2 wherein the availability engine determines availability for a particular reservation using a requesting service provider's own fleet and fleets of one or more affiliated service providers, wherein the affiliated service providers include service providers that are directly affiliated with the requesting service provider and service providers that are indirectly affiliated with the requesting service provider.

4. The platform of claim 4 in which the request for the availability information passes through the regulatory element.

5. The platform of claim 2 wherein the portions of the service provider specific data include a portion that comprises service provider specific information that is available to the search element when service providers establish an affiliate relationship between each other using the regulatory element.

6. The platform of claim 1 wherein the regulatory element permits individual service providers to assign affiliated service providers to different categories using the affiliate relationships, including hierarchical categories of service providers.

7. The platform of claim 1 in which the affiliate relationships include first level, second level and third level relationships.

8. The platform of claim 1 in which the dispatch interface element provides any service provider vehicle fleet information about any other service provider on the basis of the affiliated relationship between the service providers.

9. The platform of claim 2 wherein the regulatory element implements and tracks different price rate arrangements that a service provider has with each of its affiliated service providers.

10. The platform of claim 1 wherein the search element uses different price relationships that a requesting service provider has with each of its affiliated service providers in generating the output response.

11. The platform of claim 1 further including a live search element that provides a service operator with information about the service provider's own vehicle(s), vehicles that are in the service provider's affiliate network, and combinations thereof.

12. A computer implemented business platform for business-to-business operation between chauffeured ground transportation service providers, comprising:
a reservation element that is configured to handle the creation and management of a service-provider-to-service-provider reservation for a chauffeured motor ground transportation;
a reservation transaction object database that stores reservation objects detailing individual reservation transactions;
a regulatory element that implements a set of electronic constraints between particular service providers, wherein the constraints create and control affiliate relationships between the service providers, wherein the regulatory element records data and confirms using the recorded data that the service providers are in compliance with ground transportation operation requirements from third party sources and is further configured to determine which service providers are not in compliance or will need to update their ground transportation requirements and in response notifies service providers with sufficient information that one or more its affiliate service provider are not compliance or will need to update their status; and
a reservation interface element that is configured and adapted to permit a requesting service provider to select one of its affiliated service providers for a reservation, wherein the reservation interface element permits the requesting service provider to select an affiliated service provider from the output response to specify that the affiliated service provider should handle the reservation and generates an update to a data field that records the selection by the requesting service provider of the particular affiliate service provider to handle the reservation.

13. The platform of claim 12 wherein the compliance element uses a vehicle identification number decoder to verify service provider information.

14. The platform of claim 12 wherein the regulatory element is configured to verify information provided to the platform by one or more service providers and wherein verification is a requirement to being able to use the reservation interface.

15. The platform of claim 12 wherein the platform stores and uses quality ratings specified for individual service providers.

16. The platform of claim 12 wherein the platform requires that each service provider can only be on the platform when the platform has verified the service provider's fleet information.

17. The platform of claim 12 wherein the regulatory element permits individual service providers to assign affiliated service providers to different categories using the affiliate relationships, including hierarchical categories of service providers

18. The platform of claim 12 further comprising a search element that is configured and adapted to receive the data requirements and generate an output response based on the data requirements, service provider specific data, and electronic constraints between service providers having affiliated relationships.

19. A computer implemented method for business-to-business operations between livery car service providers, comprising:
configuring a network of computers to provide service providers with access to a business platform;
storing service provider specific data for each service provider;
creating a reservation transaction object, wherein creating the reservation transaction object includes storing the reservation transaction object in a reservation transaction object database;
collecting and analyzing the service provider specific data to determine the availability of the service providers to schedule a pick up at particular times and geographic areas;
implementing a set of electronic constraints between the service providers, wherein the constraints create and control affiliate relationships and control usage by the service providers of at least portions of the collected service provider specific data;
receiving data requirements specifying one or more reservations including a customer pickup time;
generating an output response based on the data requirements, the portions of the collected service provider specific data, and the electronic constraints;
displaying the output response to a requesting service provider;
receiving a selection of an affiliated service provider from the output response for the purpose of specifying that the affiliated service provider should handle the reservation; and
generating an update to a data field that records the selection by the requesting service provider.
